(19) United States
(12) Patent Application Publication
(10) Pub. No.: US 2026/0230858 A1
(43) Pub. Date: Aug. 6, 2026

(54) METHODS FOR CSI-RS MEASUREMENT AND REPORT CONFIGURATION UNDER SBFD OPERATION

(71) Applicant: Telefonaktiebolaget LM Ericsson (Publ), Stockholm (SE)

(72) Inventors: Zhanxian Wang, Stockholm (SE); Min Wang, Luleå (SE); Ratheesh Kumar Mungara, Stockholm (SE); Yuhang Liu, Lund (SE)

(21) Appl. No.: 19/532,137

(22) Filed: Feb. 6, 2026

Related U.S. Application Data
(60) Provisional application No. 63/754,900, filed on Feb. 6, 2025.

(51) Int. Cl. H04W 24/04; H04B 7/06; H04L 5/00; H04L 5/14

(52) U.S. Cl. CPC H04W 24/04; H04B 7/06964; H04L 5/0094; H04L 5/14

(57) ABSTRACT

Systems and methods related to Channel State Information Reference Signal (CSI-RS) measurement and reporting configuration under Subband Full Duplex (SBFD) operation. In one embodiment, a method performed by a User Equipment (UE) comprises receiving, from a network node, configuration information that configures the UE with one or more sets of thresholds, counters, and/or timers for beam failure detection based on CSI-RS measurements on SBFD symbols, non-SBFD symbols, or both SBFD and non-SBFD symbols. The method further comprises performing a beam failure detection procedure using the one or more configured sets of thresholds, counters, and/or timers for beam failure detection, based on CSI-RS measurements on SBFD symbols, non-SBFD symbols, or both SBFD and non-SBFD symbols. In this manner, CSI-RS measurement performance can be enhanced during SBFD operation such that negative impacts to, e.g., beam failure detection can be mitigated or eliminated.

### RELATED APPLICATIONS

This application claims the benefit of U.S. Provisional Patent Application No. 63/754,900, filed Feb. 6, 2025, the disclosure of which is hereby incorporated herein by reference in its entirety.

### TECHNICAL FIELD

The present disclosure relates to a telecommunications system and, more specifically, to measurement and reporting configuration under Subframe Full Duplex (SBFD) operation.

### BACKGROUND

### FDD and TDD Systems

Transmission and reception from a node, e.g. a terminal in a cellular system, can be multiplexed in the frequency domain or in the time domain (or combinations thereof). Frequency Division Duplex (FDD) as illustrated to the left in FIG. 1 implies that downlink and uplink transmission take place in different, sufficiently separated, frequency bands. Time Division Duplex (TDD), as illustrated to the right in FIG. 1, implies that downlink and uplink transmission take place in different, non-overlapping time slots. Thus, TDD can operate in unpaired spectrum, whereas FDD requires paired spectrum.

Typically, the structure of the transmitted signal in a communication system is organized in the form of a frame structure.

In more detail, the following two Information Elements (IEs) are defined in current specifications. The TDD pattern is typically configured with at least the first IE and optionally the 2^{nd} IE:
TDD-DL-UL-ConfigCommon (cell-specific)
TDD-DL-UL-ConfigDedicated (UE-specific)

The first IE is cell specific (common to all UEs) and is provided by broadcast signaling. It provides the number of slots in the TDD pattern via a reference subcarrier spacing and a periodicity such that the S-slot pattern repeats every S slots. This IE allows for very flexible configuration of the pattern characterized as follows:
A number of full downlink slots at the beginning of the pattern configured by the parameter nDownlinkSlots
A number of full uplink slots at the end of the pattern configured by the parameter nUplinkSlots
A number of downlink (‘D’) symbols following the full downlink slots configured by the parameter nDownlinkSymbols
A number of uplink (‘U’) symbols preceding the full downlink slots configured by the parameter nUplinkSlots
If there is a gap between the last downlink symbol and the first uplink symbol, then all symbols in the gap are characterized as flexible (‘F’). A symbol classified as ‘F’ can be used for downlink or uplink. A UE determines the direction in one of the following two ways:
   Detecting a Downlink Control Information (DCI) that schedules/triggers a downlink (DL) signal/channel, e.g., Physical Downlink Shared Channel (PDSCH), Channel State Information (CSI) Reference Signal (CSI-RS) or schedules/triggers an uplink (UL) signal/channel, e.g. Physical Uplink Shared Channel (PUSCH), Sounding Reference Signal (SRS), etc.
   By dedicated (UE-specific) signaling of the IE TDD-DL-UL-ConfigDedicated. This parameter overrides some or all of the ‘F’ symbols in the pattern, thus providing a semi-static indication of whether a symbol is classified as ‘D’ or ‘U’
Optionally, a 2^{nd} pattern that is concatenated to the first pattern can be configured as above. If a 2^{nd} pattern is configured, the constraint is that the sum of the periodicities of the two patterns must evenly divide 20 milliseconds (ms).

FIG. 2 shows an exemplary TDD DL/UL pattern configured by TDD-DL-UL-ConfigCommon. It consists of three full ‘D’ slots, one full ‘U’ slot, with a mixed slot in between consisting of four ‘D’ symbols and three ‘U’ symbols. The remaining seven symbols in the mixed slot are classified as ‘F.’ In other words, FIG. 2 shows an exemplary TDD DL/UL pattern consisting of S=5 slots. TDD-DL-UL-ConfigCommon configures the cell-specific pattern, and TDD-DL-UL-ConfigDedicated (if provided) UE-specifically configures the direction for some or all of the ‘F’ symbols in the cell-specific pattern.

If a UE is not configured with TDD-DL-UL-ConfigDedicated, then the pattern at the top of the diagram is what it assumes. As stated above, the network can make use of the ‘F’ symbols flexibly, by scheduling/triggering either an uplink or a downlink signal/channel in a UE specific manner. This allows for very dynamic behavior: the direction is not known to the UE a priori; rather, the direction becomes known once the UE detects a DCI scheduling/triggering a particular DL or UL signal/channel.

In contrast, the DL/UL direction for some or all of the ‘F’ symbols in a particular slot can be provided to the UE in a semi-static manner by Radio Resource Control (RRC) configuring the UE with TDD-DL-UL-ConfigDedicated. The lower part of FIG. 2 shows three exemplary configurations for overriding ‘F’ symbols in Slot 3. If the IE indicates ‘allDownlink’ or ‘allUplink’ for a particular slot (or slots), then all ‘F’ symbols in the slot are converted to either ‘D’ or ‘U,’ respectively. If the IE indicates ‘explicit,’ then a number of symbols at the beginning of the slot and/or a number of symbols at the end of the slot are indicated as ‘D’ and ‘U,’ respectively. In the example below, the first seven and the last five are indicated as ‘D’ and ‘U’, which converts some of the ‘F’ symbols (but not all in this example) to ‘D’ and ‘U.’

The key behavior in the above is that the UE-specific IE TDD-DL-UL-ConfigDedicated can only override (i.e., specify ‘D’ or ‘U’) for symbols that are configured as ‘F’ by the cell-specific IE TDD-DL-UL-ConfigCommon. In other words, a UE does not expect to have a ‘D’ symbol converted to ‘U’ or vice versa.

### Subband Full Duplex

As described in the last section, in a conventional TDD system, the entire carrier bandwidth or all carriers in the same frequency band need to be utilizing the same DL transmission or UL reception directions. This is further illustrated in FIG. 3.

For the Release 18 evolution of the New Radio (NR) system, the 3^{rd} Generation Partnership Project (3GPP) has decided to study the technical feasibilities and potential benefits of Subband Full Duplex (SBFD) systems. In such a system, a portion of a wide bandwidth carrier may be used for a different direction than that of the rest of the carrier. This is illustrated in the left-hand side of FIG. 4. That is, unlike a conventional TDD system as shown on the left-hand side of FIG. 3 where the entire bandwidth is used for DL transmission in the first three slots, the center portion of the SBFD carrier is used for UL reception while the rest of the carrier continues to be used for DL transmission as shown in the left-hand side of FIG. 4. Similarly, instead of utilizing all carriers for the same DL or UL directions in a conventional TDD system as shown in the right-hand side of FIG. 3, some carriers in the SBFD system can be used for a different direction than that of the other carriers as shown in the right-hand side of FIG. 4.

In the 3GPP Rel-18 study, the scope has been limited such that in SBFD operation, only NR base stations, which are referred to as gNodeBs (gNBs), transmit DL and receive UL simultaneously. An individual User Equipment (UE) is scheduled in only one direction (DL or UL) at a time.

The Rel-18 work item agreed on two types of the SBFD sub band configuration. One is DU configuration which is a configuration in which frequency domain DL subbands are continuous in frequency domain. Another one is DUD configuration where in frequency domain the DL subbands are discontinuous due to the UL sub band. This can be seen from FIG. 5.

### UE Measurement for RLM/BFD/CBD

The CSI-RS resources utilized for Radio Link Monitoring (RLM) and Beam Failure Detection (BFD) measurements are typically based on the Non-Zero Power (NZP) CSI-RS resource set. These measurements can be shared when measurement gaps are configured.

RLM measurements are configured at a higher layer and involve the Radio Link Failure (RLF) timers (T311 and T310), as well as the constants N311 and N310, which target a Block Error Rate (BLER) of 10% for 10% Qₒᵤₜ and 2% for Qᵢₙ

A higher-layer threshold, rlmInSyncOutOfSync Threshold, can be configured for UE to qualify as in/out of Sync. To qualify as out of sync, all the RLM Reference Signal (RLM-RS) measurements must fall below the threshold. Conversely, to qualify as in sync, at least one RLM-RS measurement must exceed the threshold. The evaluation cycles for these states are as follows:
The shortest evaluation cycle for out-of-sync determination is 200 ms.
The shortest evaluation cycle for in-sync determination is 100 ms.
   The UE uses L1 indications to the higher layer for in/Out of Sync within the specified evaluation period.

For BFD, only Qₒᵤₜ is evaluated, and the evaluation cycle is shorter. The shortest cycle for this measurement is 50 ms. Each instance of Qₒᵤₜ is counted based on a configured timer. The maximum number of Beam Failure Instances (BFIs) is determined by a higher-layer configuration. When the maximum BFI count is reached, the UE initiates the Beam Failure Recovery procedure. Reaching the maximum BFI count can also result in a Radio Link Failure, which the UE will report to the network.

Candidate Beam Detection (CBD) measurements by the UE evaluate Layer 1 Reference Signal Received Power (L1-RSRP) based on the configured CSI-RS resources and a threshold, Q_{in_LR}. The evaluation cycle for CBD is even shorter than for RLM and BFD, with the shortest period being 25 ms.

### CSI-RS Configuration on SBFD Operations

For the SBFD Work Item (WI) in Release 19, Radio Access Network (RAN) Working Group 1 (RAN1) has made the below agreements regarding CSI-RS configurations:
For a contiguous CSI-RS resource which overlaps with SBFD subband boundaries, only CSI-RS frequency resources within DL usable Physical Resource Blocks (PRBs) are valid for SBFD-aware.
   No impact on CSI-RS sequence generation
   CSI-RS sequence mapping is applied to CSI-RS resources within DL usable PRBs only (effectively, this is same as the case when the CSI-RS sequence mapped to the Resource Blocks (RBs) outside the DL usable PRBs are punctured)
For UL transmissions and DL receptions across SBFD symbols and non-SBFD symbols in different slots (each transmission/reception within a slot has either all SBFD or all non-SBFD symbols) for an SBFD aware UE, the SBFD-aware UE is provided with one of the configurations.
   Configuration 1: The transmissions/receptions are restricted to SBFD symbols only or non-SBFD symbols only
   Configuration 2: The transmissions/receptions can be in SBFD symbols and non-SBFD symbol
   For Future Study (FFS): granularity of the configuration, e.g. per UE, per channel/signal etc.
FFS whether support of configuration 2 is subject to UE capability.

Based on above agreements, the CSI-RS resources can be configured across SBFD and non-SBFD symbols. Also, the CSI-RS resource outside the DL usable PRBS are punctured.

### Beam Failure Detection and Recovery Procedure

Clause 5.17 of 3GPP Technical Specification (TS) 38.321 v 18.1.0 describes the beam failure detection and recovery procedures as shown in the following excerpt.

***** START EXCERPT FROM 3GPP TS 38.321 *****

5.17 Beam Failure Detection and Recovery procedure
The MAC entity may be configured by RRC per Serving Cell or per BFD-RS set with a beam failure recovery
procedure which is used for indicating to the serving gNB of a new SSB or CSI-RS when beam failure is detected
on the serving SSB(s)/CSI-RS(s). Beam failure is detected by counting beam failure instance indication from the
lower layers to the MAC entity. If beamFailureRecoveryConfig is reconfigured by upper layers during an ongoing
Random Access procedure for beam failure recovery for SpCell, the MAC entity shall stop the ongoing Random
Access procedure and initiate a Random Access procedure using the new configuration. The Serving Cell is
configured with two BFD-RS sets if and only if failureDetectionSetl and failureDetectionSet2 are configured for the
active DL BWP of the Serving Cell. When the SCG is deactivated, the UE performs beam failure detection on the
PSCell if bfd-and-RLM is set to true.
RRC configures the following parameters in the beamFailureRecoveryConfig, beamFailureRecoverySpCellConfig,
beamFailureRecoverySCellConfig and the radioLinkMonitoringConfig for the Beam Failure Detection and
Recovery procedure:

| | |
|---|---|
| - | beamFailureInstanceMaxCount for the beam failure detection (per Serving Cell or per BFD-RS set of |
| | Serving Cell configured with two BFD-RS sets); |
| - | beamFailureDetectionTimer for the beam failure detection (per Serving Cell or per BFD-RS set of Serving |
| | Cell configured with two BFD-RS sets); |
| - | beamFailureRecoveryTimer for the beam failure recovery procedure for SpCell; |
| - | rsrp-ThresholdSSB: an RSRP threshold for the SpCell beam failure recovery; |
| - | rsrp-ThresholdBFR: an RSRP threshold for the SCell beam failure recovery or for the beam failure recovery |
| | of BFD-RS set of Serving Cell; |
| - | powerRampingStep: powerRampingStep for the SpCell beam failure recovery; |
| - | powerRampingStepHighPriority: powerRampingStepHighPriority for the SpCell beam failure recovery; |
| - | preambleReceivedTargetPower: preambleReceivedTargetPower for the SpCell beam failure recovery; |
| - | preambleTransMax: preambleTransMax for the SpCell beam failure recovery; |
| - | scalingFactorBI: scalingFactorBI for the SpCell beam failure recovery; |
| - | ssb-perRACH-Occasion: ssb-perRACH-Occasion for the SpCell beam failure recovery using contention-free |
| | Random Access Resources; |
| - | ra-ResponseWindow: the time window to monitor response(s) for the SpCell beam failure recovery using |
| | contention-free Random Access Resources; |
| - | prach-ConfigurationIndex: prach-ConfigurationIndex for the SpCell beam failure recovery using contention- |
| | free Random Access Resources; |
| - | ra-ssb-OccasionMaskIndex: ra-ssb-OccasionMaskIndex for the SpCell beam failure recovery using |
| | contention-free Random Access Resources; |
| - | ra-OccasionList: ra-OccasionList for the SpCell beam failure recovery using contention-free Random Access |
| | Resources; |
| - | candidateBeamRSList: list of candidate beams for SpCell beam failure recovery; |
| - | candidateBeamRS-List-r16: list of candidate beams for SCell beam failure recovery or list of candidate |
| | beams for beam failure recovery of a Serving Cell for BFD-RS set one; |
| - | candidateBeamRS-List2-r17: list of candidate beams for beam failure recovery of a Serving Cell for BFD-RS |
| | set two. |

The following UE variables are used for the beam failure detection procedure:

| | |
|---|---|
| - | BFI_COUNTER (per Serving Cell or per BFD-RS set of Serving Cell configured with two BFD-RS sets): |
| | counter for beam failure instance indication which is initially set to 0. |

The MAC entity shall for each Serving Cell configured for beam failure detection:

| | 1> | if the Serving Cell is configured with two BFD-RS sets: | | | | | |
|---|---|---|---|---|---|---|---|
| | | 2> | if beam failure instance indication for a BFD-RS set has been received from lower layers: | | | | |
| | | | 3> | start or restart the beamFailureDetectionTimer of the BFD-RS set; | | | |
| | | | 3> | increment BFI_COUNTER of the BFD-RS set by 1; | | | |
| | | | 3> | if BFI_COUNTER of the BFD-RS set >= beamFailureInstanceMaxCount: | | | |
| | | | | 4> | trigger a BFR for this BFD-RS set of the Serving Cell; | | |
| | | 2> | if BFR is triggered for both BFD-RS sets of the SpCell and the Beam Failure Recovery procedure is not | | | | |
| | | | successfully completed for any of the BFD-RS sets: | | | | |
| | | | 3> | initiate a Random Access procedure (see clause 5.1) on the SpCell; | | | |
| | | 2> | if the Serving Cell is SpCell and the Random Access procedure initiated for beam failure recovery of both | | | | |
| | | | BFD-RS sets of SpCell is successfully completed (see clause 5.1): | | | | |
| | | | 3> | set BFI_COUNTER of each BFD-RS set of SpCell to 0. | | | |
| | | | 3> | consider the Beam Failure Recovery procedure successfully completed. | | | |
| | | 2> | if the beamFailureDetectionTimer of this BFD-RS set expires; or | | | | |
| | | 2> | if beamFailureDetectionTimer, beamFailureInstanceMaxCount, or any of the reference signals used for | | | | |
| | | | beam failure detection is reconfigured by upper layers or by the BFD-RS Indication MAC CE associated | | | | |
| | | | with a BFD-RS set of the Serving Cell; or | | | | |
| | | 2> | if the reference signal(s) associated with a BFD-RS set of the Serving Cell used for beam failure detection | | | | |
| | | | is changed: | | | | |
| | | | 3> | set BFI_COUNTER of the BFD-RS set to 0. | | | |
| | | 2> | if a PDCCH addressed to C-RNTI indicating uplink grant for a new transmission is received for the | | | | |
| | | | HARQ process used for the transmission of the Enhanced BFR MAC CE or Truncated Enhanced BFR | | | | |
| | | | MAC CE which contains beam failure recovery information of this BFD-RS set of the Serving Cell: | | | | |
| | | | 3> | set BFI_COUNTER of the BFD-RS set to 0; | | | |
| | | | 3> | consider the Beam Failure Recovery procedure successfully completed for this BFD-RS set and | | | |
| | | | | cancel all the triggered BFRs of this BFD-RS set of the Serving Cell. | | | |
| | | 2> | if the Serving Cell is SCell and the SCell is deactivated as specified in clause 5.9: | | | | |
| | | | 3> | set BFI_COUNTER of each BFD-RS set of SCell to 0; | | | |
| | | | 3> | consider the Beam Failure Recovery procedure successfully completed and cancel all the triggered | | | |
| | | | | BFRs of all BFD-RS sets of the Serving Cell. | | | |
| | 1> | else: | | | | | |
| | | 2> | if beam failure instance indication has been received from lower layers: | | | | |
| | | | 3> | start or restart the beamFailureDetectionTimer; | | | |
| | | | 3> | increment BFI_COUNTER by 1; | | | |
| | | | 3> | if BFI_COUNTER >= beamFailureInstanceMaxCount: | | | |
| | | | | 4> | if the Serving Cell is SCell: | | |
| | | | | | 5> | trigger a BFR for this Serving Cell; | |
| | | | | 4> | else if the Serving Cell is PSCell and, the SCG is deactivated: | | |
| | | | | | 5> | if beam failure of the PSCell has not been indicated to upper layers since the SCG was | |
| | | | | | | deactivated or since the deactivated SCG was last reconfigured with BFD-RS: | |
| | | | | | | 6> | indicate beam failure of the PSCell to upper layers. |
| NOTE: | | | | After beam failure is indicated to upper layers, the UE may stop the beamFailureDetectionTimer and | | | |
| | | | | lower layer beam failure indication while BFI_COUNTER >= beamFailureInstanceMaxCount for the | | | |
| | | | | deactivated SCG. | | | |
| | | | | 4> | else: | | |
| | | | | | 5> | initiate a Random Access procedure (see clause 5.1) on the SpCell; | |
| | | | | | 5> | if beam failure is detected for an NCR-MT: | |
| | | | | | | 6> | indicate to NCR-Fwd to cease forwarding. |

| 2> | if the beamFailureDetectionTimer expires; or | | |
|---|---|---|---|
| 2> | if beamFailureDetectionTimer, beamFailureInstanceMaxCount, or any of the reference signals used for | | |
| | beam failure detection is reconfigured by upper layers associated with this Serving Cell; or | | |
| 2> | if the reference signal(s) associated with this Serving Cell used for beam failure detection is changed: | | |
| | 3> | set BFI_COUNTER to 0. | |
| 2> | if the Serving Cell is SpCell and the Random Access procedure initiated for SpCell beam failure recovery | | |
| | is successfully completed (see clause 5.1): | | |
| | 3> | set BFI_COUNTER to 0; | |
| | 3> | stop the beamFailureRecoveryTimer, if configured; | |
| | 3> | if the Random Access procedure was triggered by beam failure recovery for NCR-MT: | |
| | | 4> | indicate to NCR-Fwd to resume forwarding using the last forwarding configuration received by |
| | | | NCR-MT as part of side control information before beam failure detection; |

| | 3> | consider the Beam Failure Recovery procedure successfully completed. |
|---|---|---|
| 2> | else if the Serving Cell is SCell, and a PDCCH addressed to C-RNTI indicating uplink grant for a new | |
| | transmission is received for the HARQ process used for the transmission of the MAC CE for BFR which | |
| | contains beam failure recovery information of this Serving Cell; or | |
| 2> | if the SCell is deactivated as specified in clause 5.9: | |
| | 3> | set BFI_COUNTER to 0; |
| | 3> | consider the Beam Failure Recovery procedure successfully completed and cancel all the triggered |
| | | BFRs for this Serving Cell. |

The MAC entity shall:

| 1> | if the Beam Failure Recovery procedure determines that at least one BFR has been triggered and not | | |
|---|---|---|---|
| | cancelled for an SCell for which evaluation of the candidate beams according to the requirements as specified | | |
| | in TS 38.133 [11] has been completed and if none of the Serving Cell(s) of this MAC entity are configured | | |
| | with two BFD-RS sets: | | |
| | 2> | if UL-SCH resources are available for a new transmission and if the UL-SCH resources can accommodate | |
| | | the BFR MAC CE plus its subheader as a result of LCP: | |
| | | 3> | instruct the Multiplexing and Assembly procedure to generate the BFR MAC CE. |
| | 2> | else if UL-SCH resources are available for a new transmission and if the UL-SCH resources can | |
| | | accommodate the Truncated BFR MAC CE plus its subheader as a result of LCP: | |
| | | 3> | instruct the Multiplexing and Assembly procedure to generate the Truncated BFR MAC CE. |
| | 2> | else: | |
| | | 3> | trigger the SR for SCell beam failure recovery for each SCell for which BFR has been triggered, not |
| | | | cancelled, and for which evaluation of the candidate beams according to the requirements as specified |
| | | | in TS 38.133 [11] has been completed. |
| 1> | if the Beam Failure Recovery procedure determines that at least one BFR for any BFD-RS set has been | | |
| | triggered and not cancelled for an SCell for which evaluation of the candidate beams according to the | | |
| | requirements as specified in TS 38.133 [11] has been completed; or | | |
| 1> | if the Beam Failure Recovery procedure determines that at least one BFR for only one BFD-RS set has been | | |
| | triggered and not cancelled for an SpCell for which evaluation of the candidate beams according to the | | |
| | requirements as specified in TS 38.133 [11] has been completed; or | | |
| 1> | if the Beam Failure Recovery procedure determines that at least one BFR has been triggered and not | | |
| | cancelled for an SCell for which evaluation of the candidate beams according to the requirements as specified | | |
| | in TS 38.133 [11] has been completed and if at least one Serving Cell of this MAC entity is configured with | | |
| | two BFD-RS sets: | | |
| | 2> | if UL-SCH resources are available for a new transmission and if the UL-SCH resources can accommodate | |
| | | the Enhanced BFR MAC CE plus its subheader as a result of LCP: | |
| | | 3> | instruct the Multiplexing and Assembly procedure to generate the Enhanced BFR MAC CE. |
| | 2> | else if UL-SCH resources are available for a new transmission and if the UL-SCH resources can | |
| | | accommodate the Truncated Enhanced BFR MAC CE plus its subheader as a result of LCP: | |
| | | 3> | instruct the Multiplexing and Assembly procedure to generate the Truncated Enhanced BFR MAC |
| | | | CE. |
| | 2> | else: | |
| | | 3> | trigger the SR for beam failure recovery of each BFD-RS set for which BFR has been triggered, not |
| | | | cancelled, and for which evaluation of the candidate beams according to the requirements as specified |
| | | | in TS 38.133 [11] has been completed; |
| | | 3> | trigger the SR for SCell beam failure recovery for each SCell for which BFR has been triggered, not |
| | | | cancelled, and for which evaluation of the candidate beams according to the requirements as specified |
| | | | in TS 38.133 [11] has been completed. |

All BFRs triggered for an SCell shall be cancelled when a MAC PDU is transmitted and this PDU includes a MAC
CE for BFR which contains beam failure information of that SCell. All BFRs triggered for a BFD-RS set of a
Serving Cell shall be cancelled when a MAC PDU is transmitted and this PDU includes an Enhanced BFR MAC CE
or Truncated Enhanced BFR MAC CE which contains beam failure recovery information of that BFD-RS set of the
Serving Cell.
**** END EXCERPT FROM 3GPP TS 38.321 ****

### SUMMARY

Systems and methods related to Channel State Information Reference Signal (CSI-RS) measurement and reporting configuration under Subband Full Duplex (SBFD) operation. In one embodiment, a method performed by a User Equipment (UE) comprises receiving, from a network node, configuration information that configures the UE with one or more sets of thresholds, counters, and/or timers for beam failure detection based on CSI-RS measurements on SBFD symbols, non-SBFD symbols, or both SBFD and non-SBFD symbols. The method further comprises performing a beam failure detection procedure using the one or more configured sets of thresholds, counters, and/or timers for beam failure detection, based on CSI-RS measurements on SBFD symbols, non-SBFD symbols, or both SBFD and non-SBFD symbols. In this manner, CSI-RS measurement performance can be enhanced during SBFD operation such that negative impacts to, e.g., beam failure detection can be mitigated or eliminated.

In one embodiment, the one or more sets of thresholds, counters, and/or timers for beam failure detection comprise a set of thresholds, counters, and/or timers commonly applicable for CSI-RS measurements during the beam failure detection procedure regardless of whether the measurements derived based on CSI-RS resources in SBFD symbols or CSI-RS resources in non-SBFD symbols.

In one embodiment, the one or more sets of thresholds, counters, and/or timers for beam failure detection comprise a first set of thresholds, counters, and/or timers applicable for CSI-RS measurements during the beam failure detection procedure that are derived based on CSI-RS resources in SBFD symbols and a second set of thresholds, counters, and/or timers applicable for CSI-RS measurements during the beam failure detection procedure that are derived based on CSI-RS resources in non-SBFD symbols.

In one embodiment, each of the one or more sets of thresholds, counters, and/or timers for beam failure detection comprise a beam failure detection timer and/or a beam failure instance maximum count.

In one embodiment, the method further comprises receiving, from the network node, configuration information that configures the UE to derive CSI-RS measurements based on only SBFD symbols, only non-SBFD symbols, or both SBFD and non-SBFD symbols. In one embodiment, the configuration information configures the UE to derive CSI-RS measurements for beam failure detection based on only SBFD symbols, only non-SBFD symbols, or both SBFD and non-SBFD symbols. In another embodiment, the configuration information configures the UE to derive CSI-RS measurements for evaluating candidate beams or CSI-RS resources based on only SBFD symbols, only non-SBFD symbols, or both SBFD and non-SBFD symbols. In another embodiment, the configuration information configures the UE to derive CSI-RS measurements for both beam failure detection and beam failure recovery using the same one or more symbol types, the one or more symbols types being only SBFD symbols, only non-SBFD symbols, or both SBFD and non-SBFD symbols.

In one embodiment, the method further comprises, based on performing the beam failure detection procedure, sending, to the network node, a report of a beam failure event detected by the UE. In one embodiment, the UE only reports beam failure events detected in SBFD symbols, the UE only reports beam failure events detected in non SBFD symbols, or the UE reports both beam failure events detected in SBFD symbols and in non-SBFD symbols. In one embodiment, the report comprises any one or more of the following: a beam failure event indicator. The symbol type(s) for which the beam failure event has been detected, a time at which the beam failure event was detected, and information that indicates one or more candidate beams for beam failure recover and the corresponding symbol type(s).

Corresponding embodiments of a UE are also disclosed. In one embodiment, a UE comprises a communication interface comprising a transmitter and a receiver. The UE further comprises processing circuitry associated with the communication interface. The processing circuitry configured to cause the UE to receive, from a network node, configuration information that configures the UE with one or more sets of thresholds, counters, and/or timers for beam failure detection based on CSI-RS measurements on SBFD symbols, non-SBFD symbols, or both SBFD and non-SBFD symbols and perform a beam failure detection procedure using the one or more configured sets of thresholds, counters, and/or timers for beam failure detection, based on CSI-RS measurements on SBFD symbols, non-SBFD symbols, or both SBFD and non-SBFD symbols.

In another embodiment, a method performed by a UE comprises receiving, from a network node, configuration information that configures the UE to use one or more symbols types for CSI-RS measurements for beam failure detection and/or beam failure recovery and/or evaluation of candidate beams or CSI-RS resources, and/or Radio Link Monitoring (RLM) related measurement activities, the one or more symbol types comprising SBFD symbols, non-SBFD symbols, or both SBFD symbols and non-SBFD symbols. The method further comprises operating in accordance with the received configuration information.

Corresponding embodiments of a UE are also disclosed. In one embodiment, a UE comprises a communication interface comprising a transmitter and a receiver. The UE further comprises processing circuitry associated with the communication interface. The processing circuitry configured to cause the UE to receive, from a network node, configuration information that configures the UE to use one or more symbols types for CSI-RS measurements for beam failure detection and/or beam failure recovery and/or evaluation of candidate beams or CSI-RS resources, and/or RLM related measurement activities, the one or more symbol types comprising SBFD symbols, non-SBFD symbols, or both SBFD symbols and non-SBFD symbols. The processing circuitry is further configured to cause the UE to operate in accordance with the received configuration information.

In another embodiment, a method performed by a UE comprises receiving, from a network node, one or more CSI-RS resource configurations for SBFD symbols, non-SBFD symbols, or both SBFD and non-SBFD symbols. The method further comprises performing CSI-RS measurements based on CSI-RS resources in SBFD symbols, non-SBFD symbols, or both SBFD symbols and non-SBFD symbols, in accordance with the one or more CSI-RS resource configurations.

In one embodiment, the one or more CSI-RS resource configurations comprise a CSI-RS resource configuration that is commonly applicable for CSI-RS resources in both SBFD symbols and non-SBFD symbols.

In one embodiment, the one or more CSI-RS resource configurations comprise a first CSI-RS resource configuration applicable for CSI-RS resources in SBFD symbols and a separate second CSI-RS resource configuration applicable for CSI-RS resources in non-SBFD symbols.

Corresponding embodiments of a UE are also disclosed. In one embodiment, a UE comprises a communication interface comprising a transmitter and a receiver. The UE further comprises processing circuitry associated with the communication interface. The processing circuitry configured to cause the UE to receive, from a network node, one or more CSI-RS resource configurations for SBFD symbols, non-SBFD symbols, or both SBFD and non-SBFD symbols and perform CSI-RS measurements based on CSI-RS resources in SBFD symbols, non-SBFD symbols, or both SBFD symbols and non-SBFD symbols, in accordance with the one or more CSI-RS resource configurations.

In another embodiment, a method performed by a UE comprises receiving, from a network node, a measurement configuration comprising a reference signal configuration that includes a reference or valid symbol type indication that indicates one or more reference or valid symbols types based on which the UE is to perform CSI-RS measurements for layer 3 mobility, wherein the one or more reference or valid symbol types are from among a set of symbol types comprising SBFD symbols and non-SBFD symbols. The method further comprises performing CSI-RS measurements based on CSI-RS resources in the one or more reference or valid symbol types indicated in the measurement configuration.

In one embodiment, the method further comprises determining whether a measurement event can be triggered considering the CSI-RS measurements. In one embodiment, the method further comprises sending, to the network node, a measurement report for the triggered measurement event.

Corresponding embodiments of a UE are also disclosed. In one embodiment, a UE comprises a communication interface comprising a transmitter and a receiver. The UE further comprises processing circuitry associated with the communication interface. The processing circuitry configured to cause the UE to receive, from a network node, a measurement configuration comprising a reference signal configuration that includes a reference or valid symbol type indication that indicates one or more reference or valid symbols types based on which the UE is to perform CSI-RS measurements for layer 3 mobility, wherein the one or more reference or valid symbol types comprise are from among a set of symbol types comprising SBFD symbols and non-SBFD symbols. The processing circuitry is further configured to cause the UE to perform CSI-RS measurements based on CSI-RS resources in the one or more reference or valid symbol types indicated in the measurement configuration.

Embodiments of a method performed by a network node are also disclosed. In one embodiment, a method performed by a network node comprises transmitting, to a UE, configuration information that configures the UE with one or more sets of thresholds, counters, and/or timers for beam failure detection based on CSI-RS measurements on SBFD symbols, non-SBFD symbols, or both SBFD and non-SBFD symbols.

In one embodiment, the one or more sets of thresholds, counters, and/or timers for beam failure detection comprise a set of thresholds, counters, and/or timers commonly applicable for CSI-RS measurements during the beam failure detection procedure regardless of whether the measurements derived based on CSI-RS resources in SBFD symbols or CSI-RS resources in non-SBFD symbols.

In one embodiment, the one or more sets of thresholds, counters, and/or timers for beam failure detection comprise a first set of thresholds, counters, and/or timers applicable for CSI-RS measurements during the beam failure detection procedure that are derived based on CSI-RS resources in SBFD symbols and a second set of thresholds, counters, and/or timers applicable for CSI-RS measurements during the beam failure detection procedure that are derived based on CSI-RS resources in non-SBFD symbols.

In one embodiment, each of the one or more sets of thresholds, counters, and/or timers for beam failure detection comprise a beam failure detection timer and/or a beam failure instance maximum count.

In one embodiment, the method further comprises transmitting, to the UE, configuration information that configures the UE to derive CSI-RS measurements based on only SBFD symbols, only non-SBFD symbols, or both SBFD and non-SBFD symbols. In one embodiment, the configuration information configures the UE to derive CSI-RS measurements for beam failure detection based on only SBFD symbols, only non-SBFD symbols, or both SBFD and non-SBFD symbols. In another embodiment, the configuration information configures the UE to derive CSI-RS measurements for evaluating candidate beams or CSI-RS resources based on only SBFD symbols, only non-SBFD symbols, or both SBFD and non-SBFD symbols. In another embodiment, the configuration information configures the UE to derive CSI-RS measurements for both beam failure detection and beam failure recovery using the same one or more symbol types, the one or more symbol types being only SBFD symbols, only non-SBFD symbols, or both SBFD and non-SBFD symbols.

In one embodiment, the method further comprises receiving, from the UE, a report of a beam failure event detected by the UE. In one embodiment, the UE only reports beam failure events detected in SBFD symbols, the UE only reports beam failure events detected in non SBFD symbols, or the UE reports both beam failure events detected in SBFD symbols and in non-SBFD symbols. In one embodiment, the report comprises any one or more of the following: a beam failure event indicator, the symbol type(s) for which the beam failure event has been detected, a time at which the beam failure event was detected, and information that indicates one or more candidate beams for beam failure recover and the corresponding symbol type(s).

Corresponding embodiments of a network node are also disclosed. In one embodiment, a network node comprises processing circuitry configured to cause the network node to transmit, to a UE, configuration information that configures the UE with one or more sets of thresholds, counters, and/or timers for beam failure detection based on CSI-RS measurements on SBFD symbols, non-SBFD symbols, or both SBFD and non-SBFD symbols.

In another embodiment, a method performed by a network node comprises transmitting, to a UE, one or more CSI-RS resource configurations for SBFD symbols, non-SBFD symbols, or both SBFD and non-SBFD symbols. In one embodiment, the one or more CSI-RS resource configurations comprise a CSI-RS resource configuration that is commonly applicable for CSI-RS resources in both SBFD symbols and non-SBFD symbols. In another embodiment, the one or more CSI-RS resource configurations comprise a first CSI-RS resource configuration applicable for CSI-RS resources in SBFD symbols and a separate second CSI-RS resource configuration applicable for CSI-RS resources in non-SBFD symbols.

Corresponding embodiments of a network node are also disclosed. In one embodiment, a network node comprises processing circuitry configured to cause the network node to transmit, to a UE, one or more CSI-RS resource configurations for SBFD symbols, non-SBFD symbols, or both SBFD and non-SBFD symbols.

In another embodiment, a method performed by a network node comprises transmitting, to a UE, a measurement configuration comprising a reference signal configuration that includes a reference or valid symbol type indication that indicates one or more reference or valid symbols types based on which the UE is to perform CSI-RS measurements for layer 3 mobility, wherein the one or more reference or valid symbol types are from among a set of symbol types comprising SBFD symbols and non-SBFD symbols.

In one embodiment, the method further comprises receiving, from the UE, a measurement report for a measurement event.

Corresponding embodiments of a network node are also disclosed. In one embodiment, a network node comprises processing circuitry configured to cause the network node to transmit, to a UE, a measurement configuration comprising a reference signal configuration that includes a reference or valid symbol type indication that indicates one or more reference or valid symbols types based on which the UE is to perform CSI-RS measurements for layer 3 mobility, wherein the one or more reference or valid symbol types are from among a set of symbol types comprising SBFD symbols and non-SBFD symbols.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates Frequency Division Duplexing (FDD), Half-Duplex FDD, and Time Division Duplexing (TDD).

FIG. 2 illustrates an exemplary TDD Downlink (DL)/Uplink (UL) pattern consisting of S=5 slots. TDD-DL-UL-ConfigCommon configures the cell-specific pattern, and TDD-DL-UL-ConfigDedicated (if provided) User Equipment (UE)-specifically configures the direction for some or all of the ‘F’ symbols in the cell-specific pattern.

FIG. 3 illustrates a conventional TDD carrier and a conventional TDD carrier system.

FIG. 4 illustrates Subband Full Duplex (SBFD) systems.

FIG. 5 illustrates a DU configuration and a DUD configuration for a SBFD system.

FIGS. 6, 7, 8, and 9 illustrate the operation of a UE and a network node, in accordance with embodiments of the present disclosure.

FIG. 10 shows an example of a communication system in accordance with some embodiments.

FIG. 11 is another example of a communication system according to some embodiments.

FIG. 12 shows a wireless device, which may be configured to operate in communication system of FIG. 10 or in communication system of FIG. 11.

FIG. 13 shows a network node in accordance with some embodiments.

FIG. 14 is a block diagram illustrating a virtualization environment in which functions implemented by some embodiments may be virtualized.

FIGS. 15A to 15D, FIGS. 16A and 16B, FIGS. 17A to 17D, FIGS. 18A and 18B, FIGS. 19A to 19D, and FIGS. 20A to 20I illustrate exemplary implementations of certain aspects of the embodiments disclosed herein.

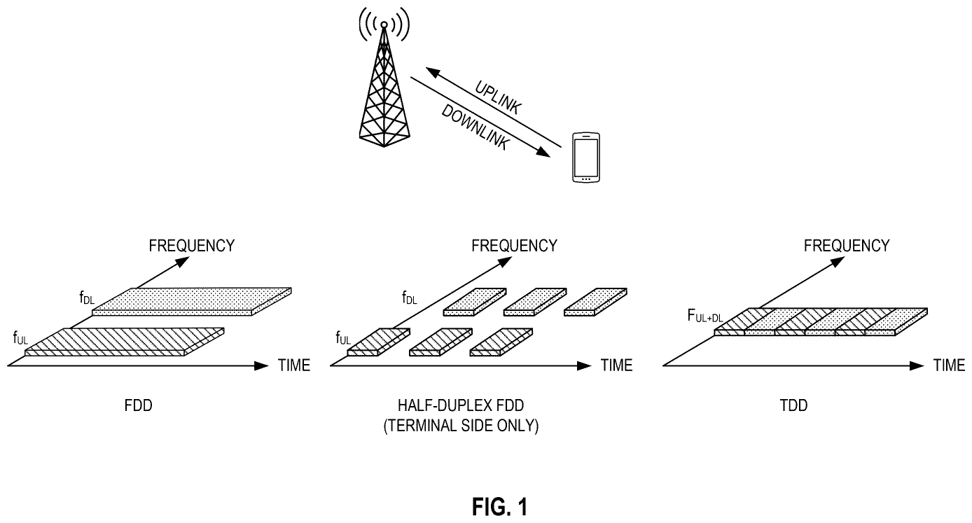

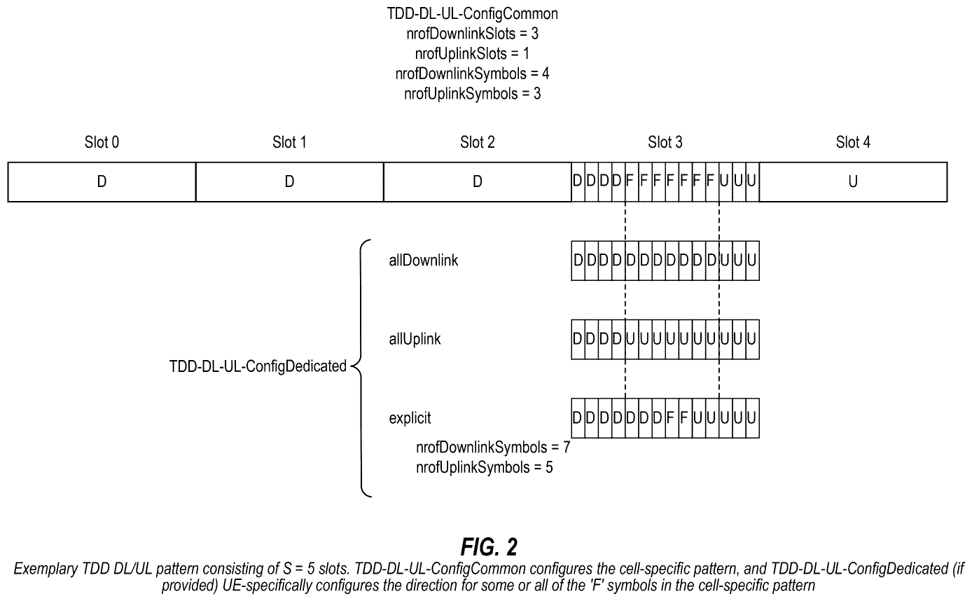

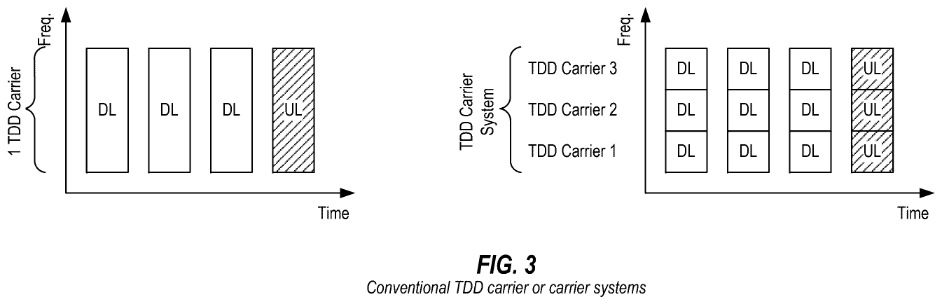

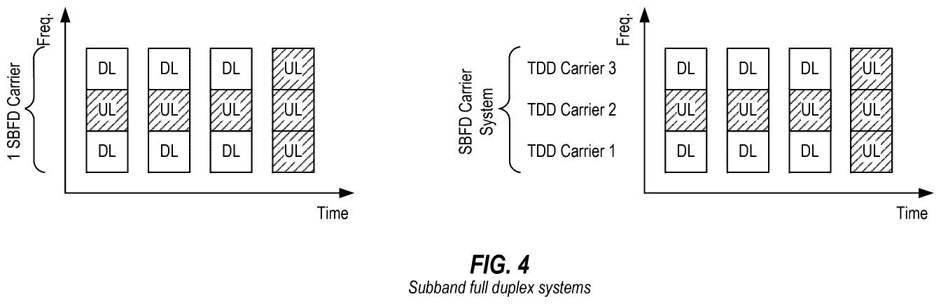

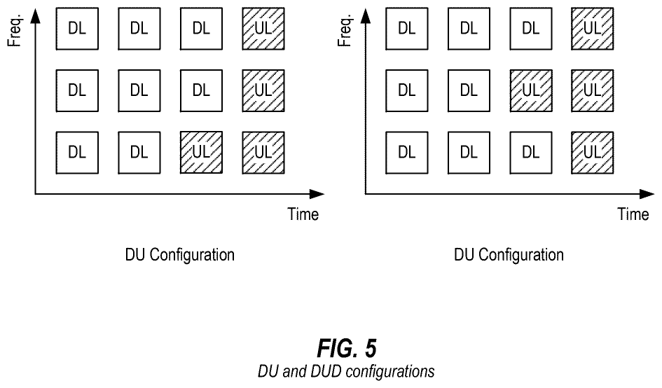

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Embodiments are provided by way of example to convey the scope of the subject matter to those skilled in the art.

There currently exist certain challenge(s). The 3^{rd} Generation Partnership Project (3GPP) Radio Access Network (RAN) Working Group 1 (RAN1) agreements on Channel State Information (CSI) Reference Signal (CSI-RS) resource configuration in Subband Full Duplex (SBFD) as described in the Section entitled “CSI-RS Configuration on SBFD Operations” in the Background above may affect CSI-RS based measurement when the configured CSI-RS resources are punctured in frequency domain if they fall outside the downlink (DL) usable Physical Resource Blocks (PRBs), and when the configured CSI-RS resource can overlap SBFD symbols and non-SBFD symbols.

Legacy User Equipment (UE) measurement behaviors are defined under the assumption of continuous CSI-RS resource allocation across certain bandwidths in the frequency domain. Discontinuous resource allocation requires a clarification of UE measurement behaviors. Additionally, both measurement delay and processing delay are based on the same type of Orthogonal Frequency Division Multiplexing (OFDM) symbols in the time domain. The 3GPP Release 19 CSI-RS resource configuration on SBFD symbols cannot ensure the legacy measurement resource assumptions. The lack of defined new UE measurement behavior can degrade measurement performance at both the beam and cell levels. This may lead to false network actions such as triggering unnecessary Beam Failure Recovery (BFR) or result in incorrect network decisions. Due to potential UE measurement behavior change and measurement performance degradation, the legacy network procedures that rely on UE measurement, such as Radio Link Monitoring (RLM), Beam Failure Detection (BFD), and Beam Failure Recovery (BFR), may be affected.

Certain aspects of the disclosure and their embodiments may provide solutions to these or other challenges. Embodiments of the present disclosure may include any one or more of the following aspects:
Network (NW) procedures and steps to cope with measurement degradation caused by CSI-RS transmission in SBFD symbols;
UE behaviors based on corresponding NW procedure to cope with the measurement performance degradation.

In a first set of embodiments, a procedure or configuration is provided to handle the potential impact due to UE measurement in SBFD symbols for RLM/BFD/BFR.

In a second set of embodiments, Frequency Domain Resource Assignment (FDRA) of CSI-RS for both SBFD and non-SBFD symbols is provided in such a manner to ensure measurement performance.

In a third set of embodiments, a procedure is provided to handle potential impact on Layer 3 (L3) or mobility measurement due to the measurement performance degradation on Layer 1 (L1)-Reference Signal Received Power (RSRP) or L1-Signal to Interference plus Noise Ratio (SINR).

Embodiments of procedures and configurations are provided herein for handling RLM/BFD/BFR due to potential measurement performance degradation, SBFD false detection of the beam failure, and the inability to distinguish the symbol type for a potential beam recovery issue.

Embodiments related to network configuration to guarantee UE measurement performance based on CSI-RS transmission in SBFD symbols are also disclosed.

Embodiments of a procedure to guarantee L3 and mobility measurement performance due to UE measurement performance degradation caused by the CSI-RS transmission in SBFD symbols are also disclosed.

Certain embodiments may provide one or more of the following technical advantage(s). Embodiments of the proposed solutions may have the following merits. The CSI-RS based L1 measurement performance can be guaranteed on SBFD symbols and the impact to crucial procedures like RLM/BFD/BFR can be eliminated. The CSI-RS based L1 measurement performance can be guaranteed for different capability UEs, and UE measurement behavior can be aligned.

Now, a more detailed description of exemplary embodiments of the present disclosure will be provided.

As used herein, an “SBFD aware UE” means a UE which is capable of operating in a cell configured with an SBFD feature, i.e., the cell or the Radio Access Network (RAN) node (i.e., next-generation Node B (gNB) in the case of New Radio (NR)) transmits downlink (DL) and receives uplink (UL) simultaneously in SBFD symbols. The UE is aware of SBFD configurations so that the UE knows which symbols are SBFD capable, which are also referred to as “SBFD symbols.” This does not mean that the UE needs to support full duplex operation. The UE may or may not support full duplex operation. The UE may, however, support the functionality allowing the gNB to operate in SBFD. The term “non SBFD symbols” means “UL symbols” as in legacy.

The embodiments below are applicable to SBFD aware UEs.

The embodiments concerning CSI-RS measurements may be applicable to both L1 and L3 CSI-RS measurements. The affected mobility measurement procedures may include link monitoring procedure, beam failure detection and recovery procedure, handover procedure (including gNB determined handover and conditional handover procedure, L1/2 triggered mobility procedure), but not limited. UE adaptive measurement method based on evaluation of the measurement interval length, the measurement period length and the numbers of usable Physical Resource Blocks (PRBs) of CSI-RS resources is being presented.

UE maintains two sets of measurement results for further action based on network configuration is being presented.

### Embodiments on BFD/BFR/RLM

In one embodiment, a UE is configured with one set of thresholds, counters, and timers for beam failure detection, wherein the set of thresholds, counters and timers comprises one beamFailureInstanceMaxCount and one beamFailureDetectionTimer. The set of thresholds, counters, and timers are commonly applicable for CSI-RS measurements during the beam failure detection procedure regardless of whether the measurements are derived based on CSI-RS resources in SBFD or non-SBFD symbols. The set of thresholds, counters and timers are configured in a conservative manner or an aggressive manner according to the symbol type for which the UE would derive CSI-RS measurements.

If the UE is configured to derive CSI-RS measurements based only on non-SBFD symbols, the number of detected beam failure instances from lower layer to trigger beam failure event in Medium Access Control (MAC) would be comparable to the legacy UE, i.e., SBFD operation unaware UE. In this case, the set of thresholds, counter and timers configured to the UE can be the same or comparable to the ones configured to the legacy UE. If the UE is configured to derive CSI-RS measurements based only on SBFD symbols, the number of detected beam failure instances from lower layer to trigger beam failure event in MAC may be larger compared to the legacy UE, i.e., beam failure event may occur more often for the UE due to measurement failure or inaccuracy for CSI-RS measurements in SBFD symbols, since transmissions of CSI-RS are punctured in UL subbands. In this case, the set of thresholds, counter and timers may be set with more conservative or more relaxed values compared to the ones configured for the legacy UE, so that beam failure event can be triggered in a less sensitive manner for the UE.

If the UE is configured to derive CSI-RS measurements based on both SBFD symbols and non-SBFD symbols, the set of thresholds, counter and timers may be set considering the ratio or percentage of CSI-RS in SBFD symbols among the total number of measured CSI-RS, compared to the set of thresholds, counters and timers configured for the legacy UEs. The set of thresholds, counters and timers are configured to the UE in a way that beam failure event triggering sensitivity is comparable, not differ much compared to the legacy UEs, and the other SBFD aware UEs.

In one embodiment, the UE is configured with two sets of thresholds, counters, or timers for beam failure detection, wherein each set of thresholds, counters and timers comprises one beamFailureInstanceMaxCount and one beamFailureDetectionTimer. One set of the thresholds, counters and timers is applicable for CSI-RS measurements during the beam failure detection procedure if the measurements are derived based on CSI-RS resources in SBFD symbols, and the other set of the thresholds, counters and timers is applicable for CSI-RS measurements during the beam failure detection procedure if the measurements are derived based on CSI-RS resources in non SBFD symbols. In this embodiment, the UE measures CSI-RS in SBFD symbols and non-SBFD symbols separately. The UE also detects beam failure instances corresponding to SBFD symbols and non SBFD symbols separately.

In one embodiment, when a beam failure event is detected/declared by the UE, the UE can be configured to report/indicate the beam failure event to the gNB according to the below configured options:
Option 1: The UE only reports beam failure events detected in SBFD symbols to the gNB.
Option 2: The UE only reports beam failure events detected in non SBFD symbols to the gNB.
Option 3: The UE reports both beam failure events detected in SBFD symbols and in non SBFD symbols to the gNB.

In the report message, the UE includes at least one of the below types of information:
1. Beam failure event indicator
2. The symbol type(s) (i.e., SBFD symbol, and/or non SBFD symbol) for which the beam failure event has been detected
3. The time when the beam failure event has been detected
4. Candidate CSI-RS or SSB resource indices (for indicating the preferred candidate beams for beam failure recovery purpose) and the corresponding symbol type(s) (i.e., SBFD symbol and/or non SBFD symbol)
   a. In this case, these candidate CSI-RS or SSB resources should have been evaluated by the UE in the corresponding symbol type(s).

In one embodiment, the UE is configured/signaled by the gNB with the symbol type(s) for CSI-RS measurements for beam failure detection. Upon reception of the signaling the UE only considers CSI-RS measurements of the indicated symbol types for beam failure detection/evaluation. The symbol type may take any of the below values:
Non SBFD symbol only
SBFD symbol only
Both SBFD symbol and non SBFD symbol
   In this option, the UE measures CSI-RS transmitted in both SBFD symbols and non SBFD symbols.
   As a further option, the UE measures CSI-RS only one symbol type within the same measurement occasion/measurement window. Thus, even though the UE can measure CSI-RS transmissions in both symbol types, the UE will not mix measurement results of different symbol types in a measurement window.
   As a further option, the UE can measure CSI-RS transmissions in both symbol types, the UE is allowed to mix measurement results of different symbol types in a measurement window. The UE may further apply weight factors when computing the filtered measurement results using measurement results from both symbol types in the same measurement window.

In one embodiment, the UE is configured/signaled by the gNB with the symbol type(s) for CSI-RS measurements for evaluating candidate beams/CSI-RS resources. Upon reception of the signaling the UE only considers CSI-RS measurements of the indicated symbol type(s) for evaluating candidate beams/CSI-RS resources.

In one embodiment, the UE is configured/signaled by the gNB with the same symbol type(s) for both beam failure detection/evaluation purpose and beam failure recovery purpose (i.e., evaluation of candidate beams/CSI-RS resources). Upon reception of the signaling, the UE only considers CSI-RS measurements of the indicated symbol type(s) for beam failure detection and beam failure recovery purpose.

In one embodiment, the UE is configured/signaled by the gNB with the symbol type(s) for other RLM related measurement activities (e.g., Radio Link Failure (RLF) detection). The UE performs measurements for RLF detection (out-of-sync/in-sync) based on measurements associated with the indicated symbol type. As an option, the UE is configured with different thresholds for measurements based on non SBFD and SBFD symbols. When the UE detects an RLF event and subsequently recovers from it, the RLF report includes the type(s) of symbols where the RLF event was detected. In other words, the UE has detected the RLF event based on measurement results associated with the indicated symbol type(s).

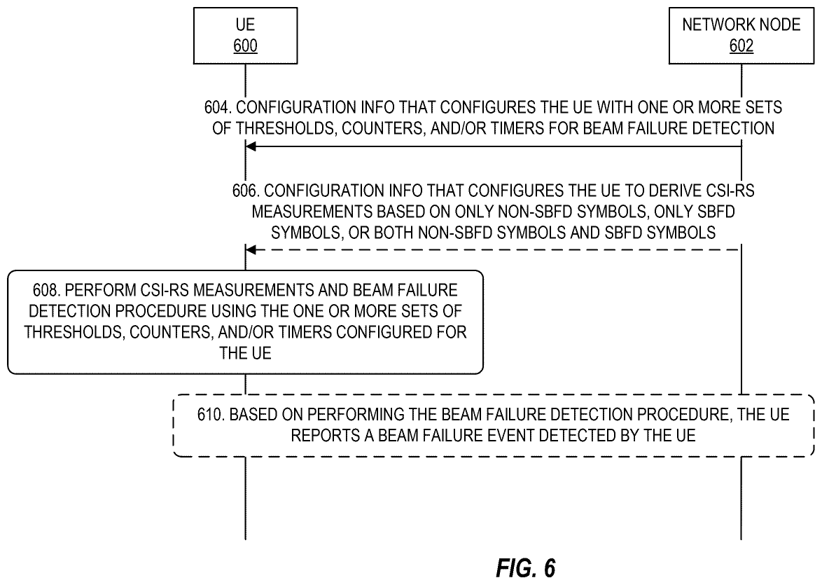

FIG. 6 illustrates the operation of a UE 600 and a network node 602, in accordance with at least some of the embodiments described above. Note that while not all of the details about the embodiments described above are repeated here in the description of FIG. 6, it is to be understood that those details are equally applicable to the corresponding steps or aspects of procedure FIG. 6. The network node 602 is a RAN node such as a base station (e.g., a gNB or similar 6G base station) or a RAN node that performs some of the functionality of a base station (e.g., a gNB-Distributed Unit (DU) or gNB-Central Unit (CU) in the case of a distributed gNB architecture). Further, not all steps of FIG. 6 are required.

As illustrated, the UE 600 receives, from the network node 602, configuration information that configures the UE 600 with one or more sets of thresholds, counters, and/or timers for BFD (step 604). As discussed above, in one embodiment, the UE 600 is configured with one set of thresholds, counters, and timers for beam failure detection, wherein the set of thresholds, counters and timers comprises one beamFailureInstanceMaxCount and one beamFailureDetectionTimer. The set of thresholds, counters, and timers are commonly applicable for CSI-RS measurements during the beam failure detection procedure regardless of whether the measurements are derived based on CSI-RS resources in SBFD or non-SBFD symbols. The set of thresholds, counters and timers are configured in a conservative manner or an aggressive manner according to the symbol type for which the UE would derive CSI-RS measurements. As also discussed above, in another embodiment, the UE 600 is configured with two sets of thresholds, counters, or timers for beam failure detection, wherein each set of thresholds, counters and timers comprises one beamFailureInstanceMaxCount and one beamFailureDetectionTimer. One set of the thresholds, counters and timers is applicable for CSI-RS measurements during the beam failure detection procedure if the measurements are derived based on CSI-RS resources in SBFD symbols, and the other set of the thresholds, counters and timers is applicable for CSI-RS measurements during the beam failure detection procedure if the measurements are derived based on CSI-RS resources in non SBFD symbols. In this embodiment, the UE measures CSI-RS in SBFD symbols and non-SBFD symbols separately. The UE also detects beam failure instances corresponding to SBFD symbols and non SBFD symbols separately.

Optionally, the UE 600 also receives, from the network node 602, configuration information that configures the UE 600 to derive CSI-RS measurements based on only non-SBFD symbols, only SBFD symbols, or both non-SBFD symbols and SBFD symbols (step 606). As discussed above, in one embodiment, the UE 600 is configured to derive CSI-RS measurements for beam failure detection based on only non-SBFD symbols, only SBFD symbols, or both non-SBFD symbols and SBFD symbols. In another embodiment, the UE 600 is configured to derive CSI-RS measurements for evaluating candidate beams or CSI-RS resources based on only non-SBFD symbols, only SBFD symbols, or both non-SBFD symbols and SBFD symbols. In one embodiment, the UE 600 is configured to use the same symbol types for both beam failure detection/evaluation and beam failure recover. In one embodiment, the UE 600 is also configured to use one or more of the aforementioned symbol types for other RLM measurement activities (e.g., RLF detection).

The UE 600 performs CSI-RS measurements and performs a beam failure detection procedure using the one or more sets of thresholds, counters, and/or timers configured in step 604 (based on the performed CSI-RS measurements) (step 608). Based on performing the beam failure detection procedure, the UE 600 sends, to the network node 602, a beam failure report for a beam failure event detected by the UE 600 (step 610). As discussed above, in one option, the UE 600 only reports beam failure events detected in SBFD symbols to the network node 602. In another option, the UE 600 only reports beam failure events detected in non-SBFD symbols to the network node 602. In another option, the UE 600 reports both beam failure events detected in SBFD symbols and beam failure events in non-SBFD symbols to the network node 602. Further, as discussed above, the beam failure report may include any one or more of the various types of information described above.

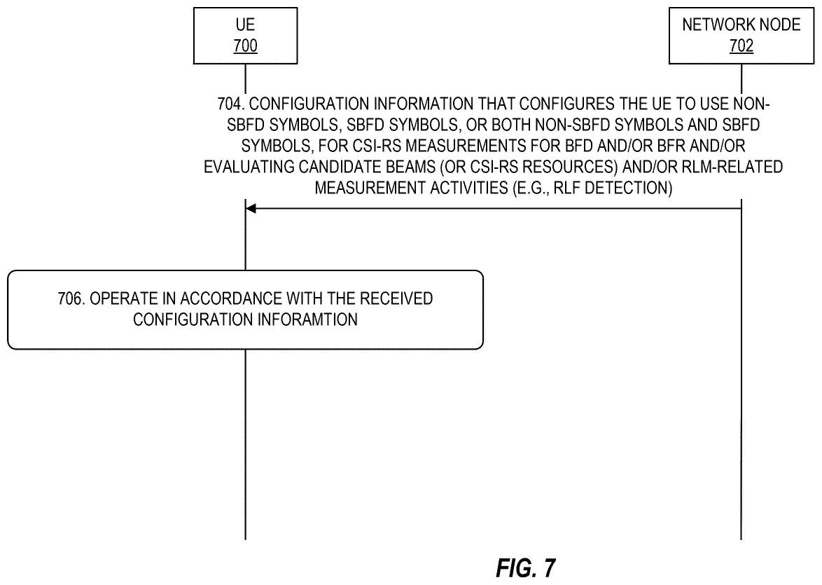

FIG. 7 illustrates the operation of a UE 700 and a network node 702, in accordance with at least some of the embodiments described above. Note that while not all of the details about the embodiments described above are repeated here in the description of FIG. 7, it is to be understood that those details are equally applicable to the corresponding steps or aspects of procedure FIG. 7. The network node 702 is a RAN node such as a base station (e.g., a gNB or similar 6G base station) or a RAN node that performs some of the functionality of a base station (e.g., a gNB-Distributed Unit (DU) or gNB-Central Unit (CU) in the case of a distributed gNB architecture). Further, not all steps of FIG. 6 are required.

As illustrated, the UE 700 receives, from the network node 702, configuration information that configures the UE 700 to use one or more symbols types (i.e., non-SBFD symbols,

SBFD symbols, or both non-SBFD symbols and SBFD symbols) for CSI-RS measurements for beam failure detection and/or beam failure recovery and/or evaluation of candidate beams or CSI-RS resources and/or RLM-related measurement activities (e.g., RLF detection) (step 704). The UE 700 operates in accordance with the configuration information (step 706). In particular, the UE 700 performs BFD, BFR, beam evaluation, and/or RLM related activity(s) using CSI-RS measurements on the indicated symbol type(s).

### Embodiments on FDRA of the CSI-RS for Both SBFD and Non-SBFD Symbols

Note that while the following embodiments are described here under a separate heading, these embodiments may be combined with any of the other embodiments described under the other headings above or below.

The network can configure the CSI-RS in both SBFD and non-SBFD symbols using various options to ensure that the measurement performance of the CSI-RS is not affected by discontinuous CSI-RS resources in the frequency domain across two downlink subbands within an SBFD symbol.
Option 1: Configure different Frequency Domain Resource Assignments (FDRAs) for CSI-RS in SBFD and non-SBFD symbols with the same number of valid PRBs in both type of symbols.
   This implies dedicated configurations of CSI-RS resources for SBFD and non-SBFD symbols.
Option 2: Configure the same FDRA for CSI-RS in SBFD and non-SBFD symbols with a larger number of PRBs so that even in SBFD symbols with reduced number of valid PRBs the requirement for CSI-RS measurement can still be met.
   This implies configuration of common CSI-RS resources across SBFD and non-SBFD symbols but requires larger PRB allocation in non-SBFD symbols than minimum requirement.
Option 3: Restrict CSI-RS transmission to be within one DL subband (no overlapping with UL subband or guard-bands)
   This implies configuration of common CSI-RS resources for both SBFD and non-SBFD symbols, wherein the CSI-RS resources are confined within one DL subband.

In one embodiment, the UE is configured with different CSI-RS resource configurations for SBFD symbol and non-SBFD symbol. A dedicated CSI-RS resource configuration for SBFD symbols is provided by the network, wherein the configuration ensures the number of continuous PRBs of the CSI-RS resources exceeds certain threshold in at least one downlink subband.

In another embodiment, the UE is configured with the same CSI-RS resource configuration for SBFD and non-SBFD symbols. The configuration of the CSI-RS resources for both SBFD and non-SBFD symbols ensures the number of continuous PRBs of the CSI-RS resources exceeds certain threshold in at least one downlink subband.

In another embodiment, the UE is configured with the same CSI-RS resource configuration for SBFD and non-SBFD symbols. The configuration ensures the CSI-RS resource configuration in frequency domain is restricted to be within one downlink subband in SBFD symbols, wherein the number of continuous PRB of the CSI-RS resources exceeds certain threshold in the downlink subband.

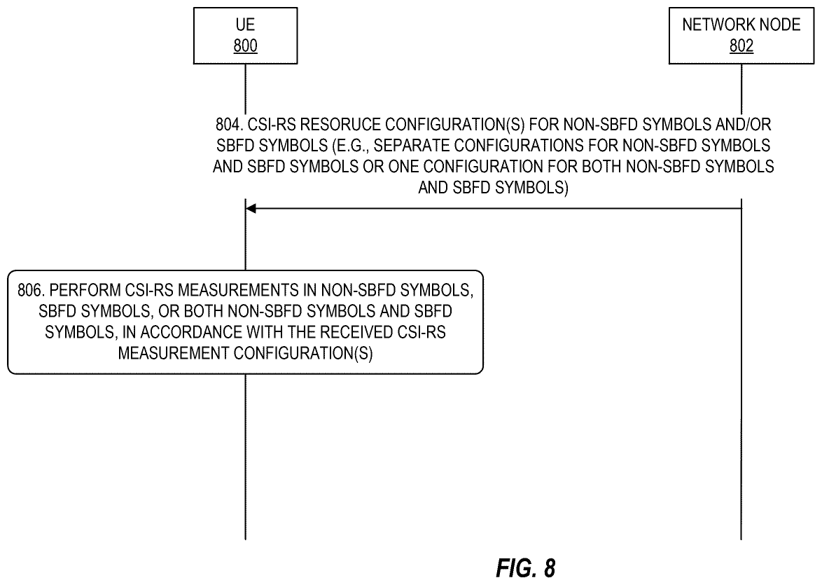

FIG. 8 illustrates the operation of a UE 800 and a network node 802, in accordance with at least some of the embodiments described above. Note that while not all of the details about the embodiments described above are repeated here in the description of FIG. 8, it is to be understood that those details are equally applicable to the corresponding steps or aspects of procedure FIG. 8. The network node 802 is a RAN node such as a base station (e.g., a gNB or similar 6G base station) or a RAN node that performs some of the functionality of a base station (e.g., a gNB-Distributed Unit (DU) or gNB-Central Unit (CU) in the case of a distributed gNB architecture). Further, not all steps of FIG. 8 are required. Lastly, while illustrated separately from that of FIG. 6, the procedure of FIG. 8 may be combined with (or used as part of) the procedure of FIG. 6 (e.g., to configure the FDRA for CSI-RS for both SBFD and non-SBFD symbols, e.g., sometime prior to step 608).

As illustrated in FIG. 8, the UE 800 receives, from the network node 802, one or more CSI-RS resource configurations for non-SBFD and SBFD symbols (step 804). As discussed above, in one embodiment, the UE 800 is configured with separate CSI-RS resource configurations for SBFD symbols and non-SBFD symbols. In another embodiment, the UE 600 is configured with one CSI-RS resource configuration for both SBFD symbols and non-SBFD symbols. Further details regarding the CSI-RS resource configuration(s) are provided above.

The UE 800 performs one or more actions (e.g., CSI-RS measurements) in accordance with the received CSI-RS resource configuration(s) (step 806). More specifically, the UE 800 performs CSI-RS measurements in non-SBFD symbols, SBFD symbols, or both non-SBFD symbols and SBFD symbols, in accordance with the received CSI-RS measurement configuration(s) from step 804.

### Embodiments on L3 Mobility

The network configures a set of Reference Signal (RS) resources for Layer 3 (L3) mobility measurement. If the network configures the UE to measure Synchronization Signal (SS)/Physical Broadcast Channel (PBCH) Blocks (SSBs) for L3 mobility, there is little impact on the UE mobility performance expected. However, if the network configures the UE to measure CSI-RSs for L3 mobility, the UE may derive measurements based on CSI-RS transmitted in non-SBFD symbols and/or SBFD symbols.

In one embodiment, the UE is configured with a measurement object including referenceSignalConfig wherein a reference or valid symbol type is included (i.e., signaled) in CSI-RS related configuration, i.e., same as what is described in the above embodiments of the Section entitled “Embodiments on BFD/BFR/RLM”, which indicates the reference or valid symbol types based on which the UE is to perform CSI-RS based measurement for L3 mobility.
As an example, the UE may consider L1 measurement results associated with non-SBFD symbols to derive L3 measurement results.
As an example, the UE may consider L1 measurement results associated with SBFD symbols to derive L3 measurement results.
As an example, the UE may consider L1 measurement results associated with both non-SBFD symbols and SBFD symbols to derive L3 measurement results.

In one embodiment, when the UE determines whether a measurement event can be triggered considering CSI-RS measurement results, the UE considers measurement results associated with the symbol type (configured for the measurement event trigger). The symbol type indicates one of the following options:
Non-SBFD symbol
SBFD symbol
Both SBFD symbol and non-SBFD symbol

Thus, when a measurement event is triggered, the UE may send a measurement report with respect to the triggered measurement event. The measurement report may include an indicator indicating symbol type(s) associated with the measurement event. In other words, the indicator indicates the symbol types based on measurements associated with the symbol types, the measurement event has been triggered.

Alternatively, separate (new) measurement events are introduced/defined for different symbol types. As an example, measurement event A3:
Event A3 (Neighbor becomes offset better than SpCell).
Two separate A3 events (i.e., A3X and A3Y), wherein A3X is defined for trigger based on measurement results of non SBFD symbols, and A3Y is defined for trigger based on measurement results of SBFD symbols.

As another example, a new measurement event A3X is defined for trigger based measurement results on SBFD symbols. Meanwhile, the legacy event A3 is defined for triggered based on measurement results of non-SBFD symbols. In one embodiment, the UE provides a measurement report containing both cell level measurement results and beam level measurements of several beams (e.g., the beams with top channel quality) for each serving cell/neighbor cell. The cell level measurement results and/or the beam level measurement results may also comprise an indicator indicating the symbol type(s) according to which the measurement results are derived.

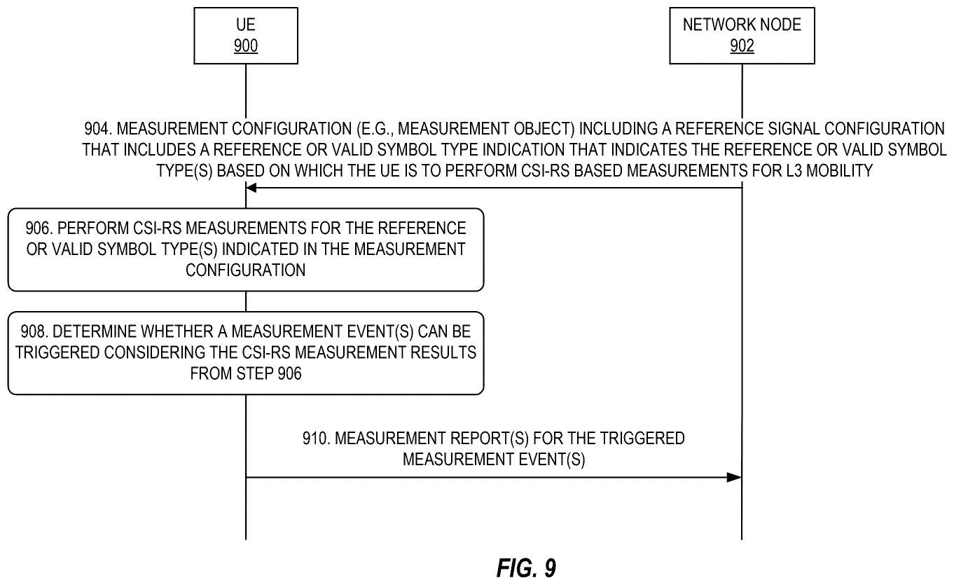

FIG. 9 illustrates the operation of a UE 900 and a network node 902, in accordance with at least some of the embodiments described above. Note that while not all of the details about the embodiments described above are repeated here in the description of FIG. 9, it is to be understood that those details are equally applicable to the corresponding steps or aspects of procedure FIG. 9. The network node 902 is a RAN node such as a base station (e.g., a gNB or similar 6G base station) or a RAN node that performs some of the functionality of a base station (e.g., a gNB-Distributed Unit (DU) or gNB-Central Unit (CU) in the case of a distributed gNB architecture). Further, not all steps of FIG. 9 are required. Lastly, while illustrated separately from that of FIG. 6 and FIG. 8, the procedure of FIG. 9 may be combined with (or used as part of) the procedure of FIG. 6 and/or the procedure of FIG. 8.

As illustrated in FIG. 9, the UE 900 receives, from the network node 902, a measurement configuration (e.g., a measurement object) including a reference signal configuration that includes an reference or valid symbol type indication that indicates the reference or valid symbol type(s) (e.g., non-SBFD, SBFD, or both non-SBFD and SBDF symbols) based on which the UE 900 is to perform CSI-RS based measurements for L3 mobility (step 904). In other words, the reference or valid symbol type indication indicates the reference or value symbol type(s) from among a set of symbol types comprising SBFD symbols and non-SBFD symbols). As discussed above, the UE 900 may consider L1 measurement results associated with non-SBFD symbols to derive L3 measurement results, may consider L1 measurement results associated with SBFD symbols to derive L3 measurement results, or may consider L1 measurement results associated with both non-SBFD symbols and SBFD symbols to derive L3 measurement results. Whether the UE 900 considers L1 measurement results associated with non-SBFD symbols, SBFD symbols, or both non-SBFD symbols and SBFD symbols is indicated by the reference or valid symbol type(s) indication included in the measurement configuration.

The UE 900 performs CSI-RS measurements for the configured reference or value symbol type(s) indicated in the measurement configuration of step 904, in accordance with the measurement configuration (step 906). The UE 900 determines whether a measurement event can be triggered considering the CSI-RS measurement results for the configured reference or value symbol type indicated in the measurement configuration (step 908) and sends, to the network node 902, a measurement report(s) for the triggered measurement event(s) (step 910).

### ASN.1 Implementation Examples of the Embodiments

### Implementation Examples for BFD/BFR/RLM

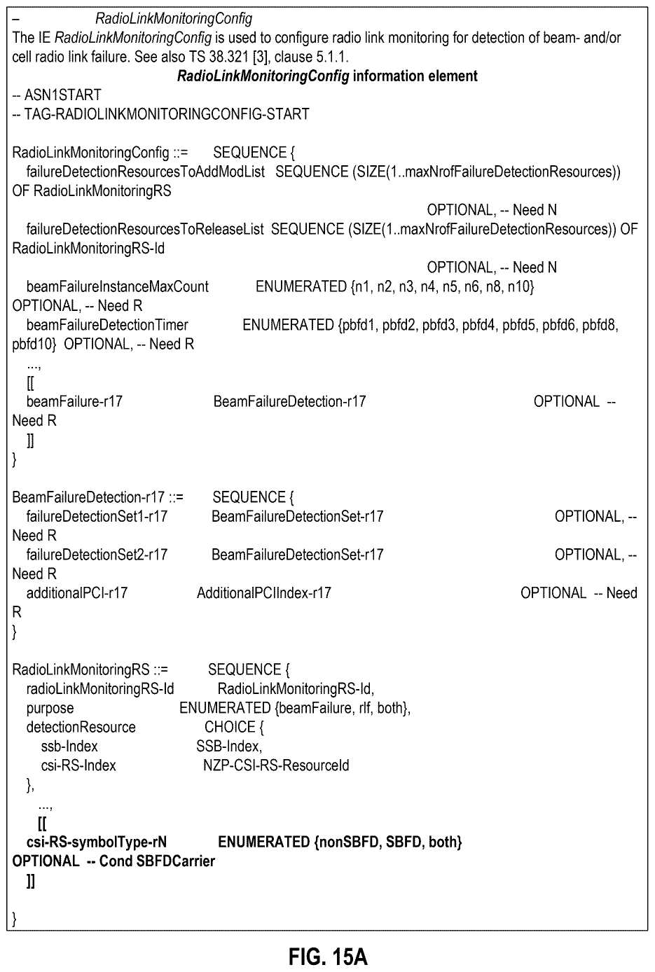

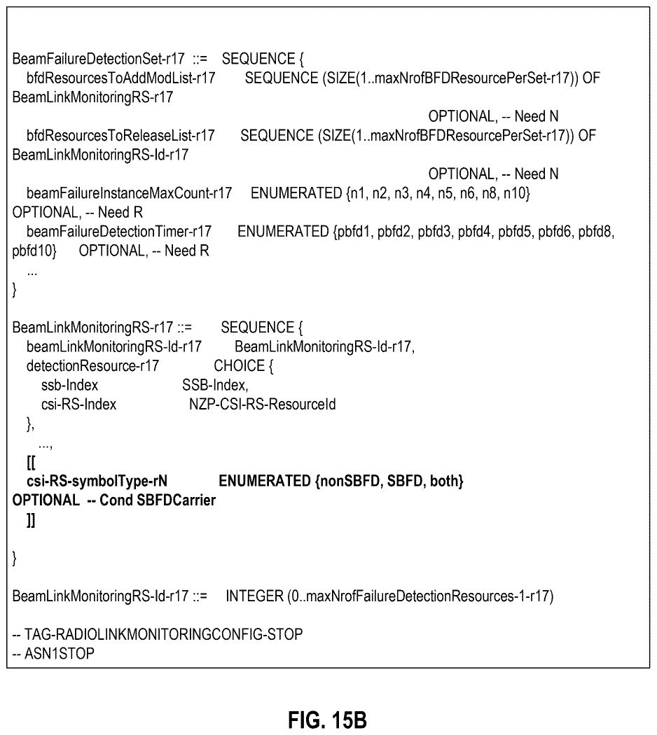

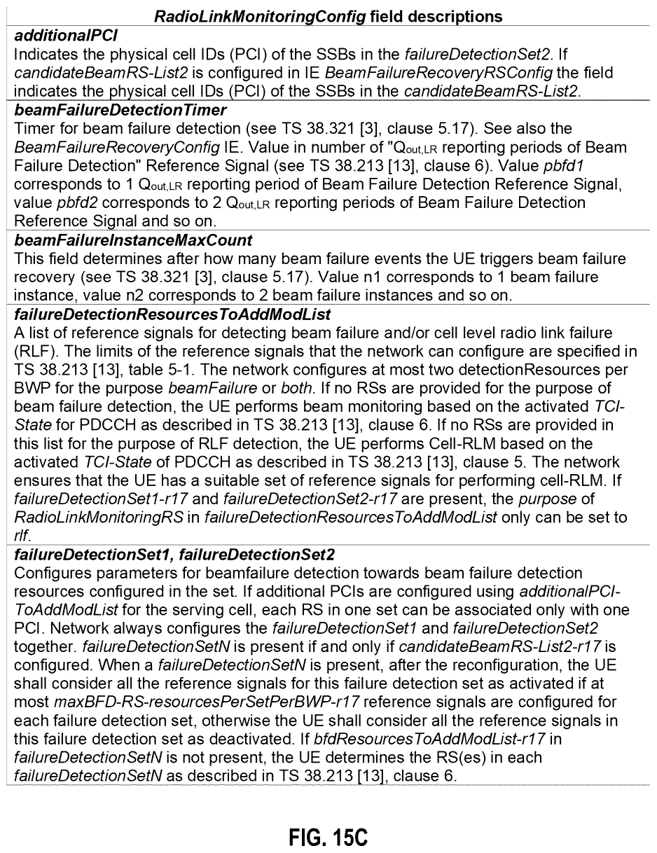

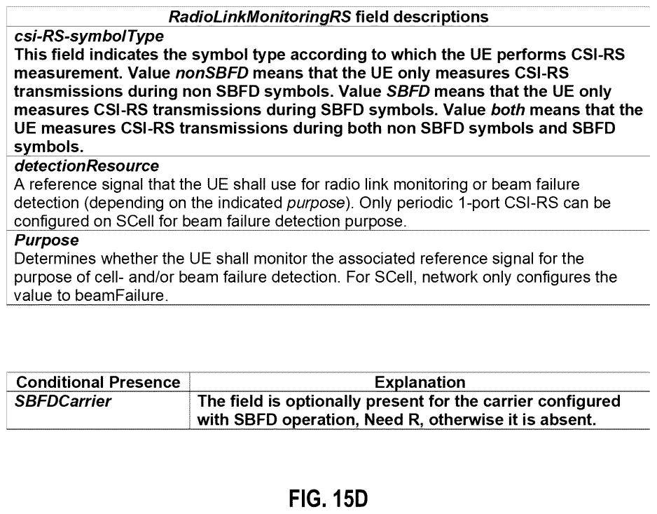

In one implementation example, the above methods impacting the ASNI of the RRC specification may be represented in 3GPP TS 38.331 v 18.4.0 as follows in the RadioLinkMonitoringConfig conveying the configuration for radio link monitoring provided by the gNB, as shown in FIGS. 15A to 15D. The implementation has only covered part of the proposed information elements/changes. In this example, a field indicating the valid symbol type is included. The field indicates the symbol type for which the UE shall measure CSI-RS transmissions for triggering BFD and RLF. In this example, the field is included in IE RadioLinkMonitoringRS so that this field can be configured per CSI-RS resource.

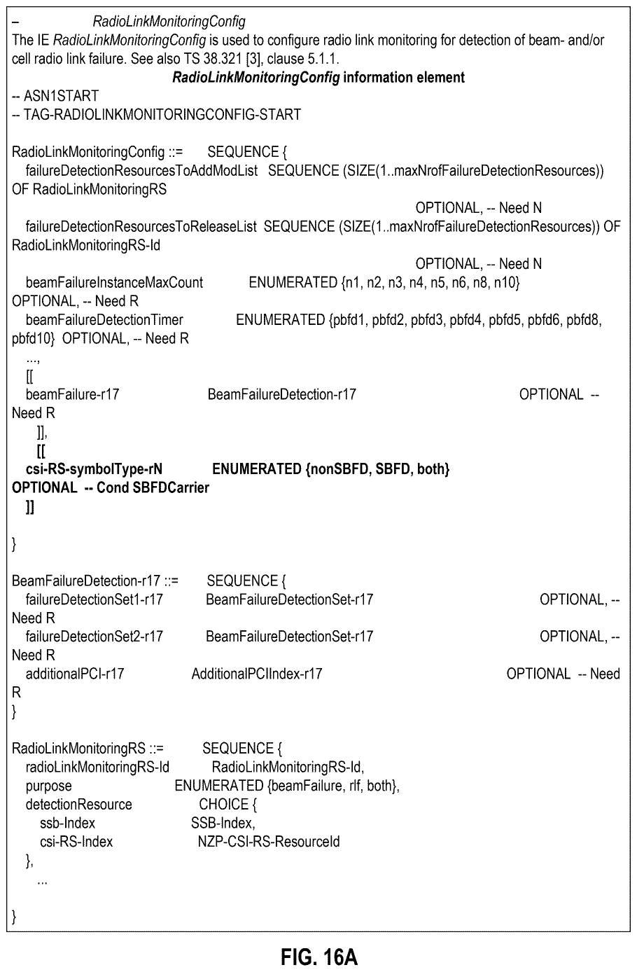

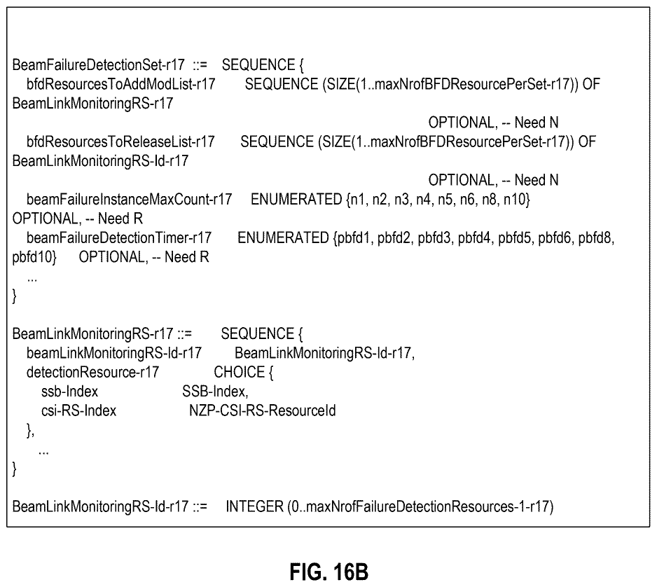

In one implementation example, the above methods impacting the ASNI of the RRC specification may be represented in 3GPP TS 38.331 v 18.4.0 as follows in the RadioLinkMonitoringConfig conveying the configuration for radio link monitoring provided by the gNB, as illustrated in FIGS. 16A and 16B. The implementation has only covered part of the proposed information elements/changes. In this example, a field indicating the valid symbol type is included. The field indicates the symbol type for which the UE shall measure CSI-RS transmissions for triggering BFD and RLF. In this example, the field is included in IE RadioLinkMonitoringConfig so that this field can be configured to be common for all configured CSI-RS resources.

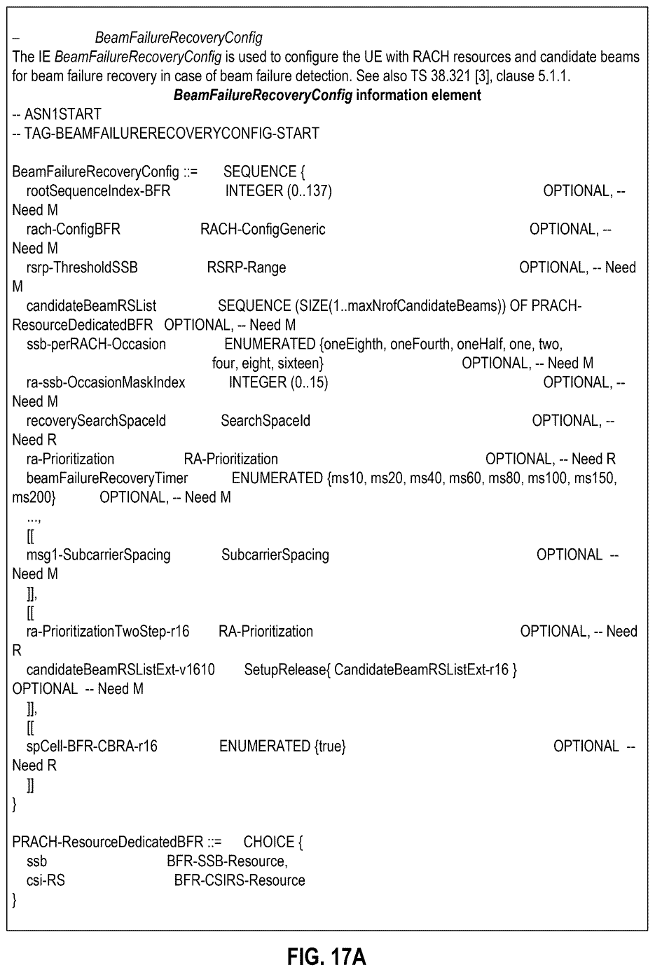

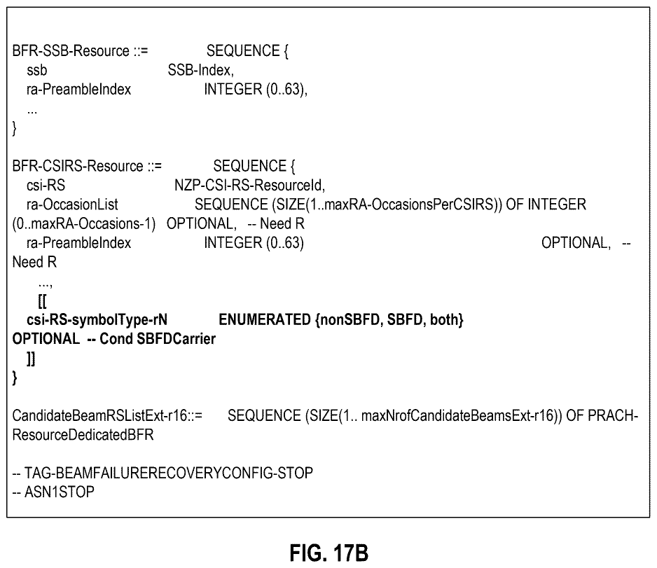

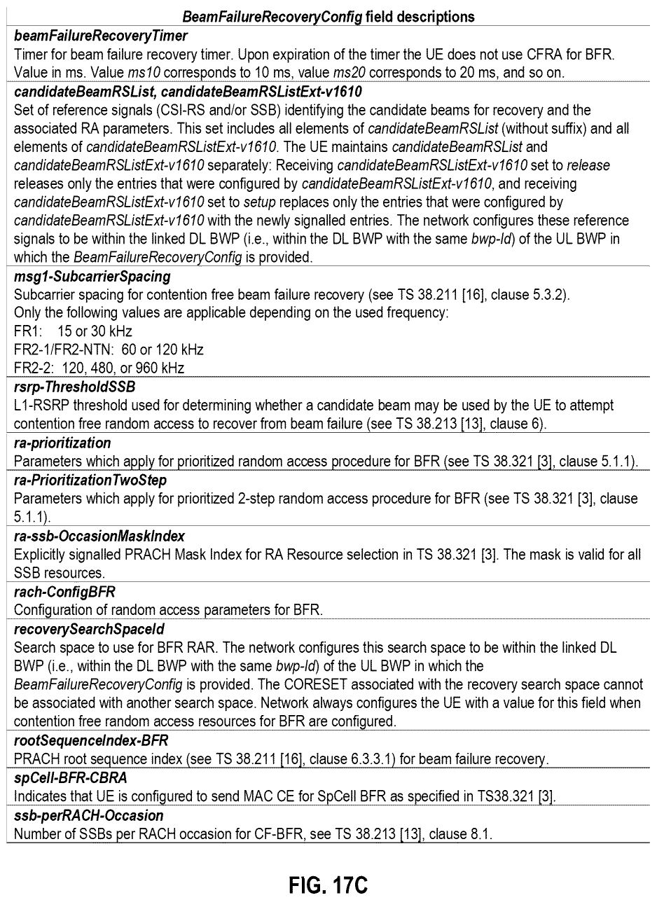

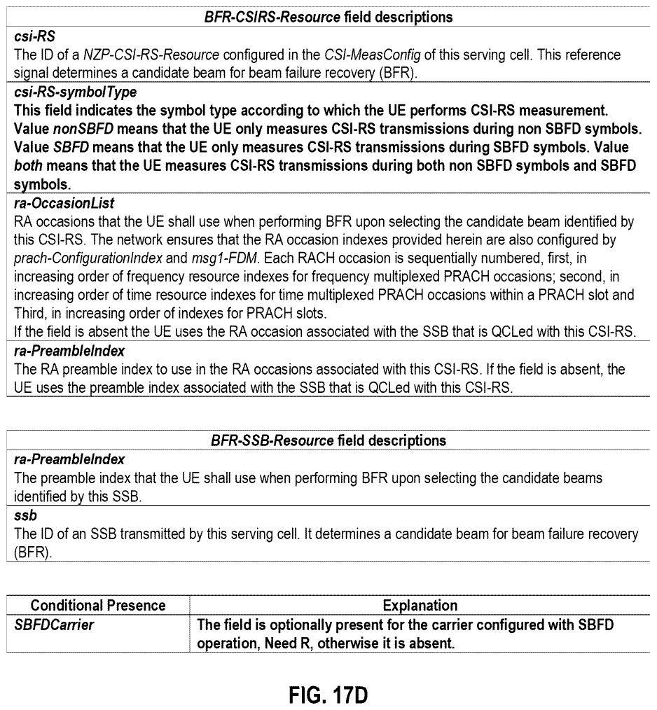

In another example, the above methods impacting the ASNI of the RRC specification may be represented in 3GPP TS 38.331 v 18.4.0 as follows in the BeamFailureRecoveryConfig conveying the configuration for beam failure recovery/candidate beam detection provided by the gNB, as shown in FIGS. 17A to 17D. The implementation has only covered part of the proposed information elements/changes. In this example, a field indicating the valid symbol type is included. The field indicates the symbol type for which the UE shall measure CSI-RS transmissions for evaluating candidate beams during beam failure recovery procedure. In this example, the field is included in IE BFR-CSIRS-Resource so that this field can be configured per configured CSI-RS resources.

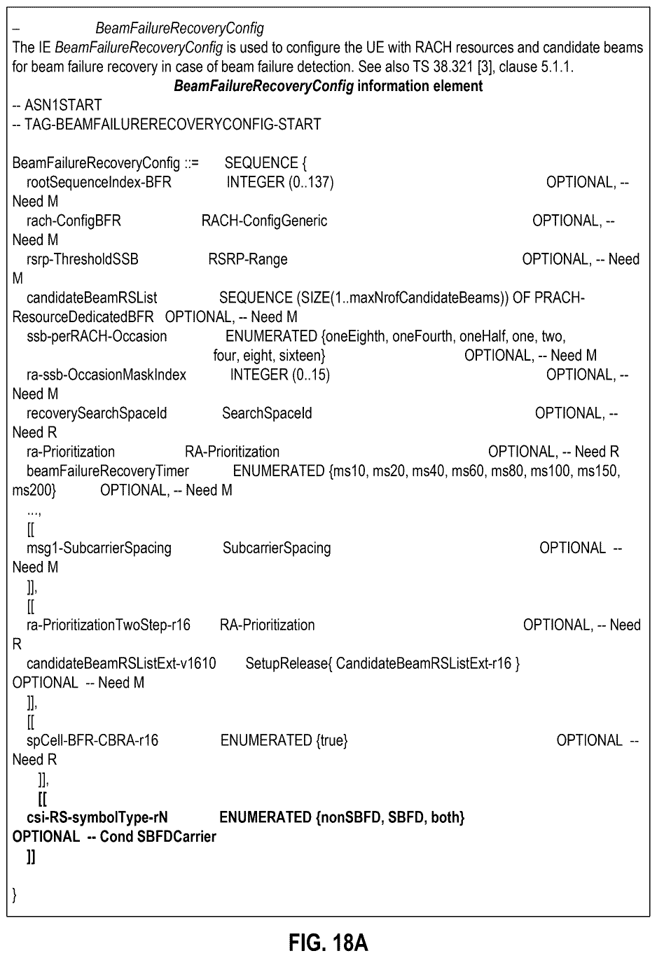

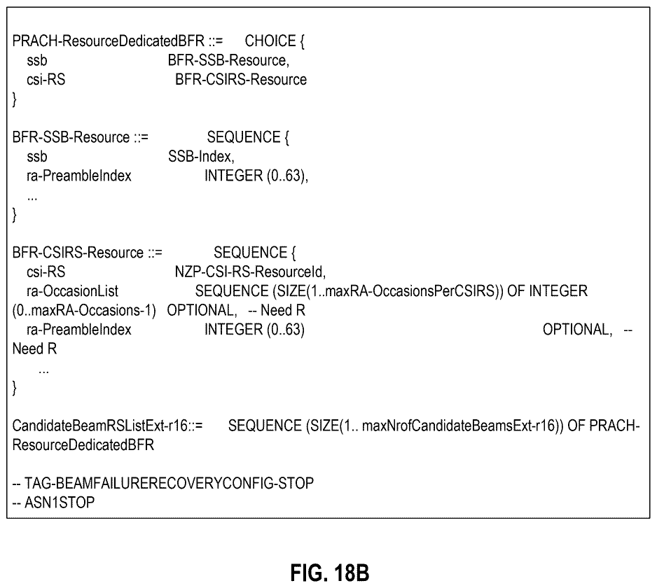

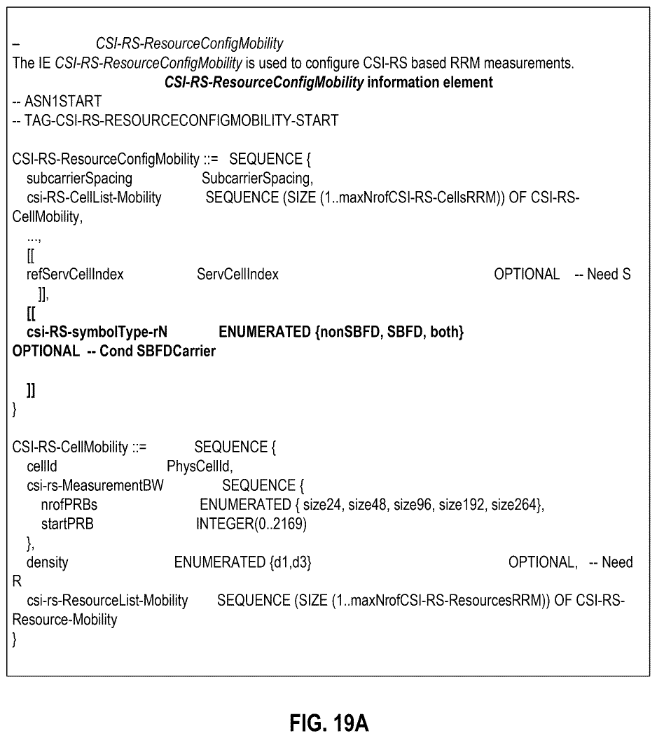

In yet another example, the above methods impacting the ASNI of the RRC specification may be represented in 3GPP TS 38.331 v 18.4.0 as follows in the BeamFailureRecoveryConfig conveying the configuration for beam failure recovery/candidate beam detection provided by the gNB, as illustrated in FIGS. 18A and 18B. The implementation has only covered part of the proposed information elements/changes. In this example, a field indicating the valid symbol type is included. The field indicates the symbol type for which the UE shall measure CSI-RS transmissions for evaluating candidate beams during beam failure recovery procedure. In this example, the field is included in IE BeamFailureRecoveryConfig so that this field can be configured to be common for all configured CSI-RS resources.

### Implementation Examples for L3 Mobility

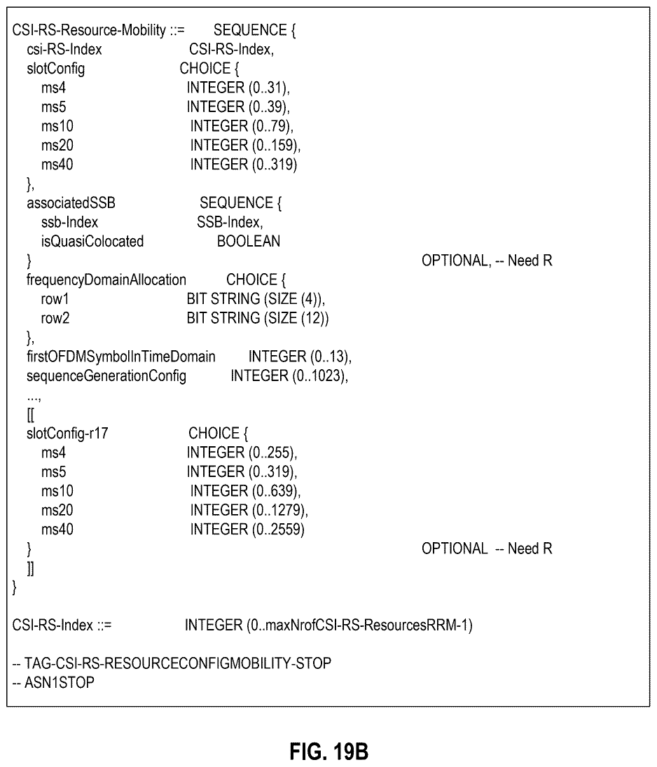

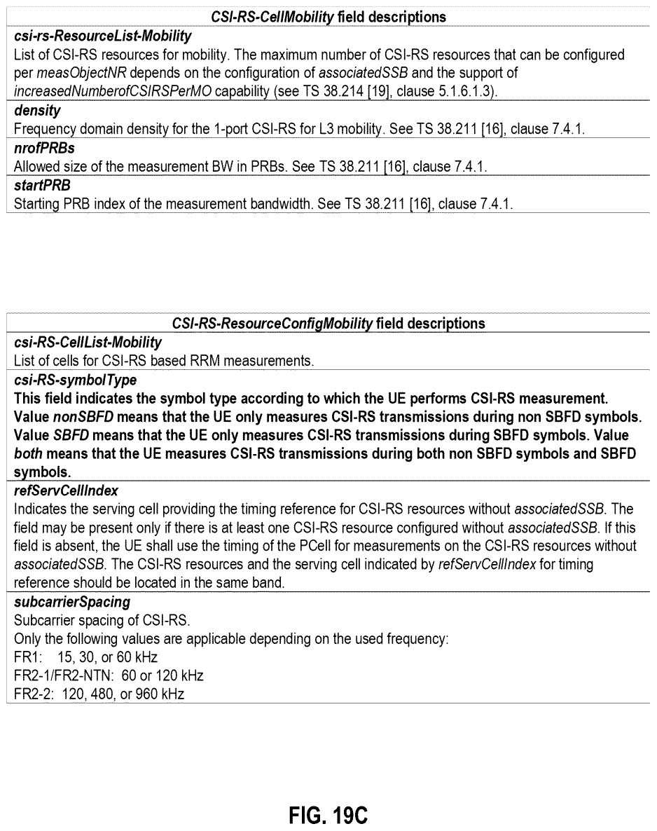

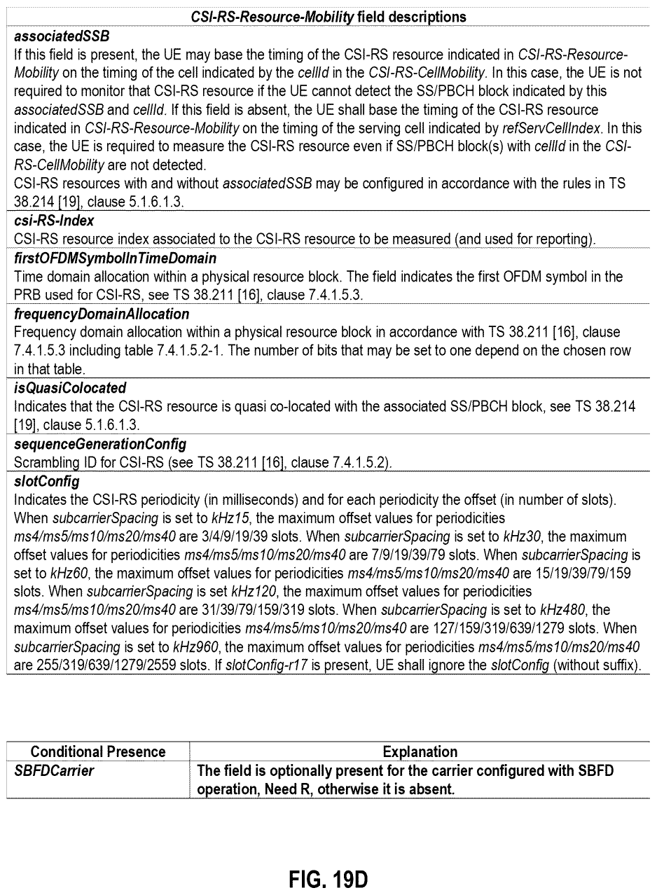

In one implementation example, the above methods impacting the ASNI of the RRC specification may be represented in 3GPP TS 38.331 v 18.4.0 as follows in the CSI-RS-ResourceConfigMobility conveying the configuration for CSI-RS mobility configuration provided by the gNB, as illustrated in FIGS. 19A to 19D. The implementation has only covered part of the proposed information elements/changes. In this example, a field indicating the symbol type is included. The field indicates the symbol type for which the UE shall measure CSI-RS transmissions for triggering L3 mobility, e.g., handover.

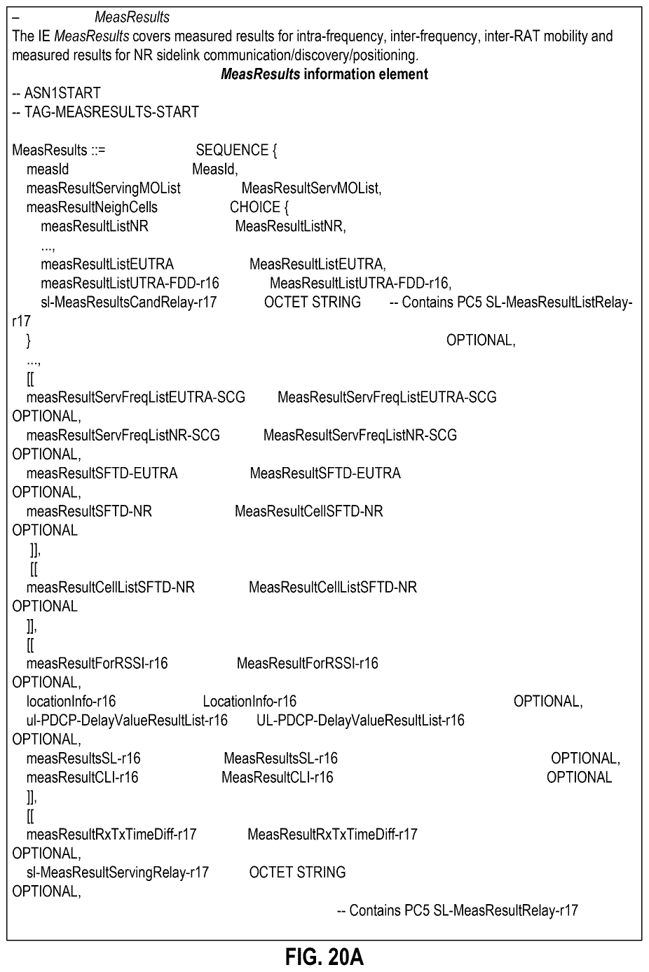

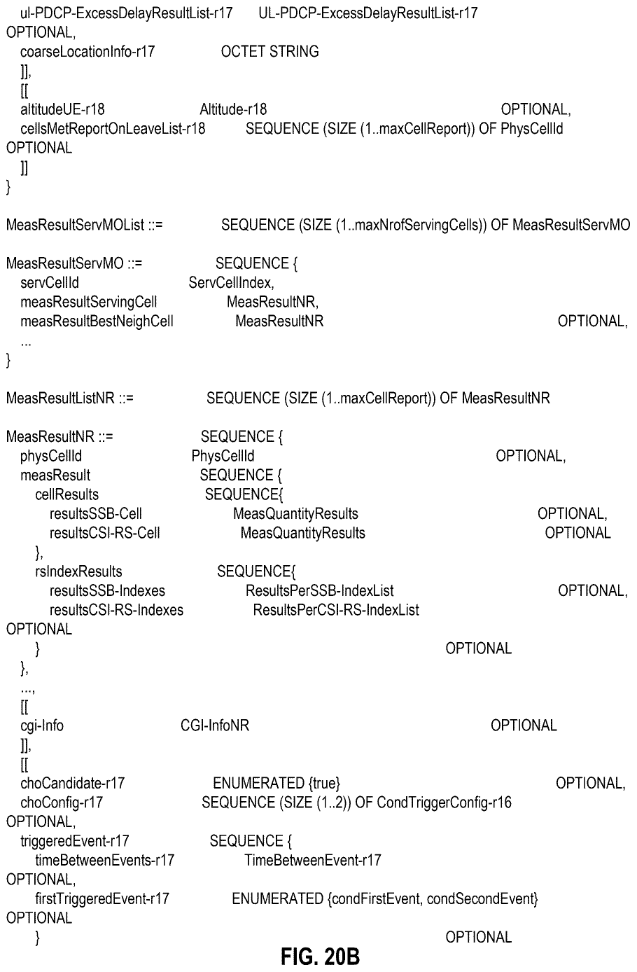

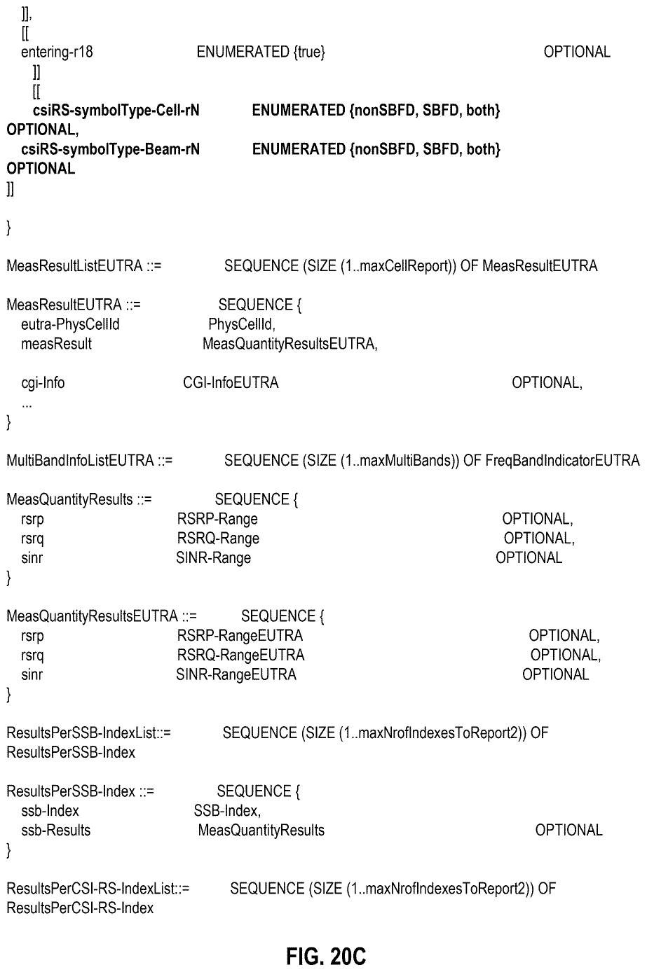

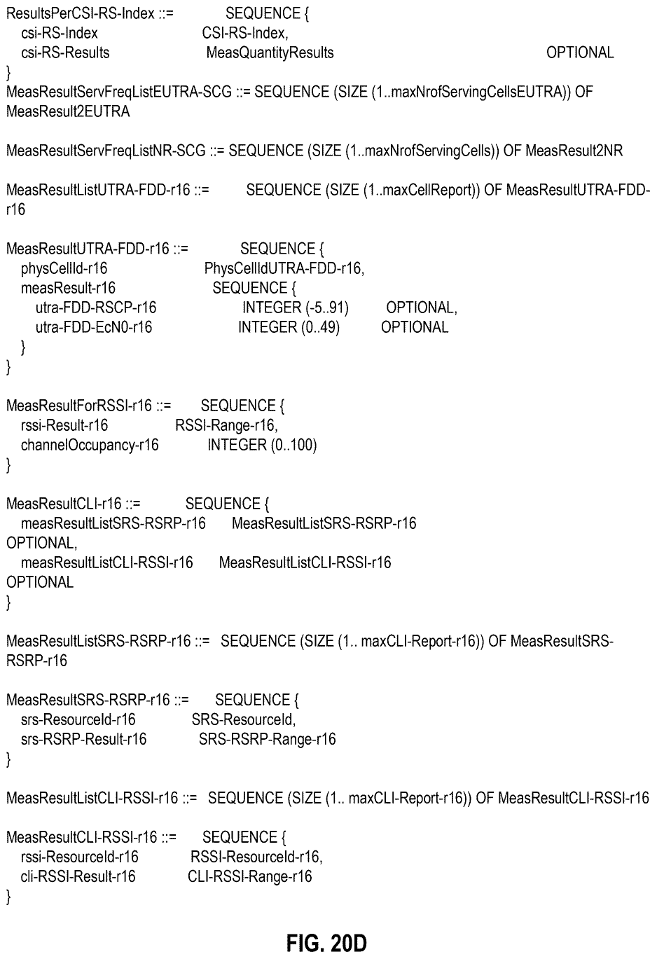

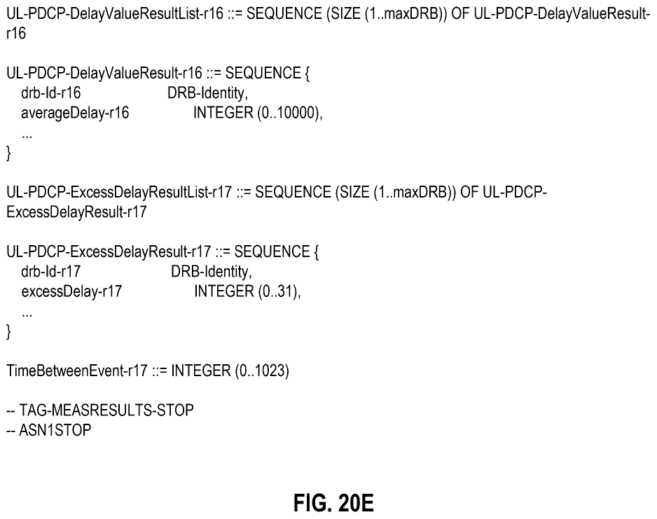

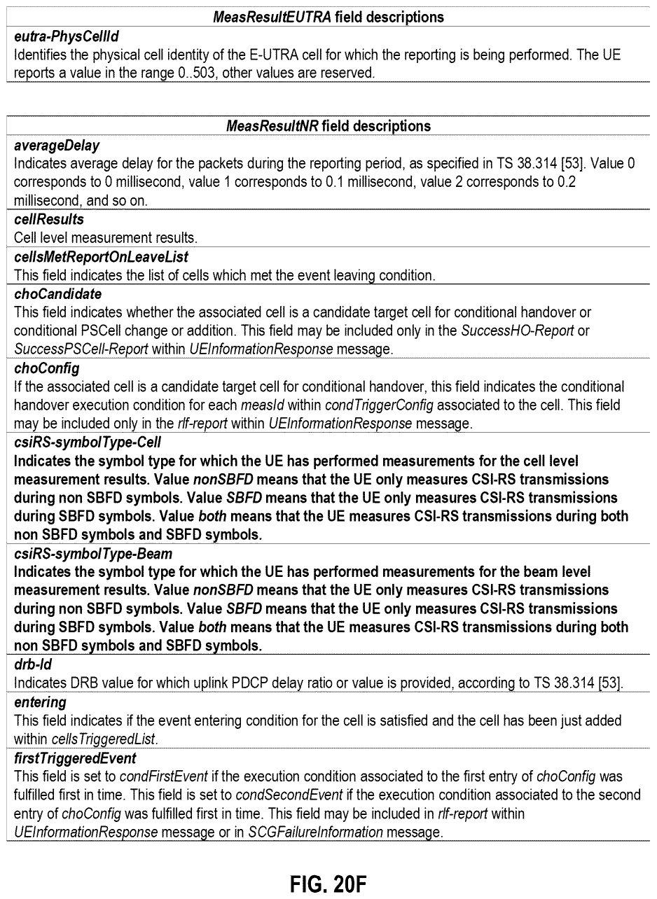

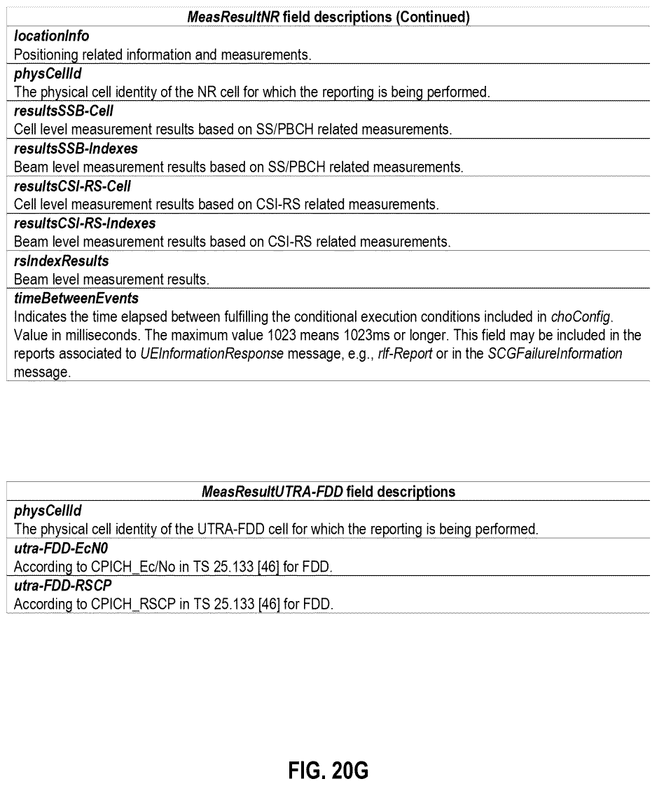

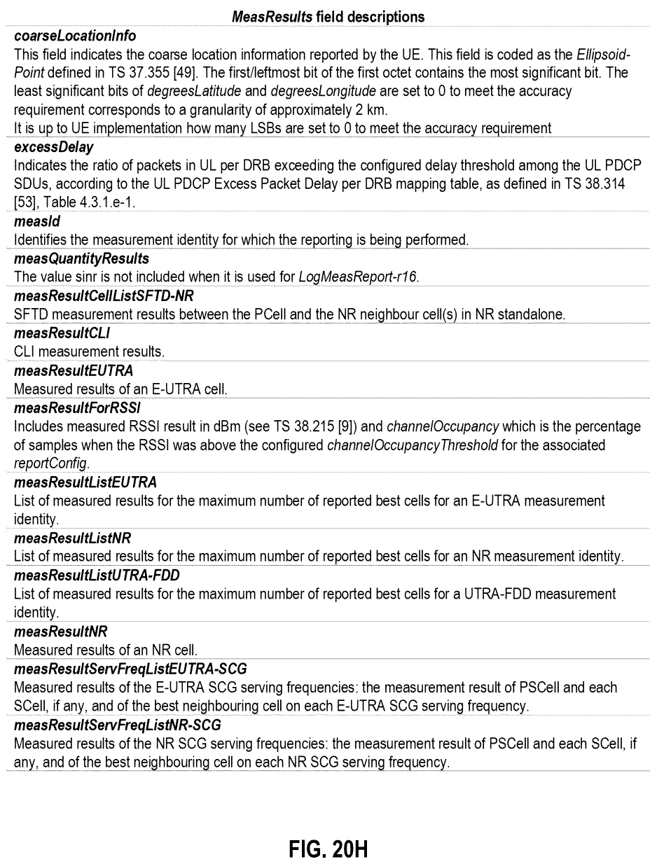

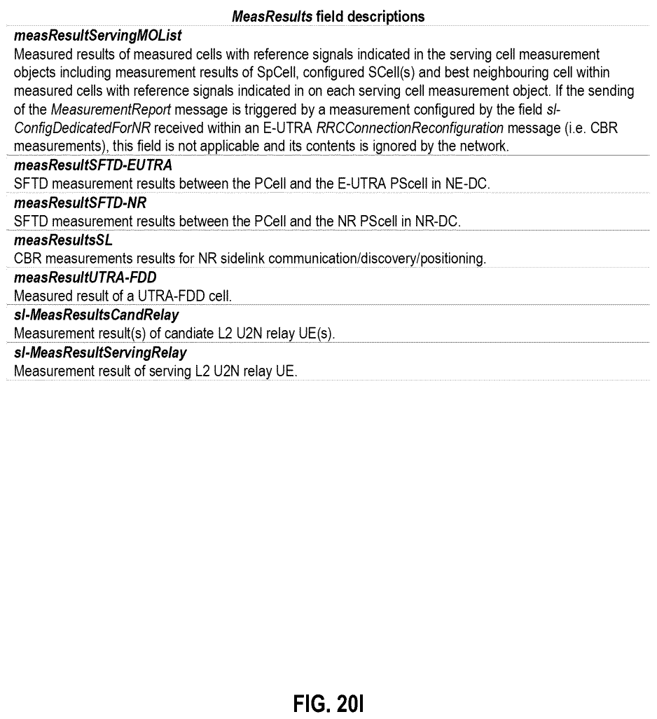

In one implementation example, the above methods impacting the ASNI of the RRC specification may be represented in 3GPP TS 38.331 v 18.4.0 as follows in the CSI-RS-ResourceConfigMobility conveying the configuration for CSI-RS mobility configuration provided by the gNB, as illustrated in FIG. 20A to 20I. The implementation has only covered part of the proposed information elements/changes. In this example, a field indicating the symbol type is included. The two fields indicate the symbol type for which the UE has measured CSI-RS transmissions for triggering L3 mobility, e.g., handover. One field indicates the symbol type for which the UE has measured CSI-RS transmissions for cell level measurement results. One field indicates the symbol type for which the UE has measured CSI-RS transmissions for beam level measurement results.

### Further Description Related to All Embodiments

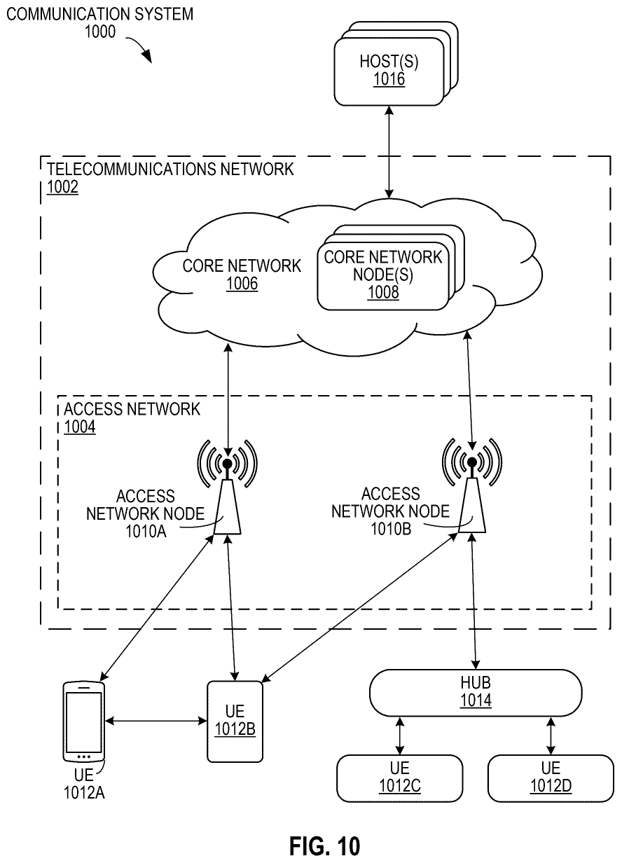

FIG. 10 shows an example of a communication system 1000 in accordance with some embodiments.

In the example, the communication system 1000 includes a telecommunications network 1002 that includes an access network 1004, such as a radio access network (RAN), and a core network 1006, which includes one or more core network nodes 1008. The access network 1004 includes one or more access network nodes or base stations of various types, access network nodes 1010A and 1010B are depicted (which may be collectively referred to as network nodes 1010), or any other similar 3^{rd} Generation Partnership Project (3GPP) access nodes or non-3GPP access points (APs). Some embodiments of the access network 1004 may include more than one access network technology. The network nodes 1010 of access network 1004 facilitate direct or indirect connection of wireless devices, also referred to as user equipments (UEs), such as by connecting UEs 1012A, 1012B, 1012C, and 1012D (one or more of which may be generally referred to as UEs 1012) to the core network 1006 over one or more wireless connections.

Moreover, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunications network 1002 includes one or more Open-RAN (ORAN) network nodes. An ORAN network node is a network node in the telecommunications network 1002 that supports an ORAN specification (e.g., a specification published by the O-RAN Alliance, or any similar organization) and may operate alone or together with other network nodes to implement one or more functionalities of any network node in the telecommunications network 1002, including one or more access network nodes 1010 and/or core network nodes 1008.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). An ORAN network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies.

The network nodes 1010 facilitate direct or indirect connection of one or more UEs 1012 to the core network 1006 over one or more wireless connections. Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1008, 1010 are arranged, capable, configured, and/or operable to communicate directly or indirectly (e.g., via other devices of telecommunications network 1002) with the UEs 1012 and/or with other network nodes or equipment in the telecommunications network 1002 to enable and/or provide network access, such as wireless network access, and/or to perform other functions, such as administration in the telecommunications network 1002. More specifically, UEs 1012 may send messages, data, and/or other signals to network nodes 1008, 1010 or other elements of the telecommunications network 1002 by transmitting such signals to the relevant device directly without the signals passing through any intervening devices or by transmitting such signals to the relevant device indirectly through an intervening device (or multiple intervening devices) that then transmit the signal to the relevant device. Similarly, network nodes 1008, 1010 may send messages, data, and other signals to UEs 10122, other network nodes 1008, 1010, and other devices in telecommunications network 1002 directly or indirectly. As one specific example, a core network node 108 may transmit a particular message to a UE 1012 by transmitting the message to an access network node 1010 that will then transmit the message to the intended UE 1012. Similarly, a core network node 108 may receive a particular message from a UE 1012 by receiving the message from an access network node 1010 that itself received the message from the UE 1012.

In the depicted example, the core network 1006 connects elements of the access network 1004 (e.g., one or more of the network nodes 1010) to one or more host computing systems, such as host 1016. These connections may be direct or indirect via one or more intermediary networks or devices. In other examples, network nodes may be directly coupled to hosts. The core network 1006 includes one or more core network nodes (e.g., core network node 1008) of various types, one or more of which may be generally referred to as network nodes 1008. Network nodes 1008 are structured with hardware and software components. Features of these components may be substantially similar to those described with respect to the UEs, access network nodes, and/or hosts, such that the descriptions thereof are generally applicable to the corresponding components of the core network node 1008. Example core network nodes provide functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunications network 1002. The host 1016 may be operated by the service provider or on behalf of the service provider. The host 1016 may host a variety of applications to provide one or more services. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system 1000 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (Wi-Fi); and/or any other appropriate wireless communication standard, such as the Worldwide Interoperability for Microwave Access (Wi-Max), Bluetooth, Z-Wave, Near Field Communication (NFC) ZigBee, Li-Fi, and/or any low-power wide-area network (LPWAN) standards such as LoRa and Sigfox. Moreover, the communication system 1000 may be configured to support multiple different standards, protocols, or other rule sets, with individual components supporting all of the relevant rule sets or with different components or sub-systems within the communication system 1000 supporting different standards, protocols, or rule sets.

As one example, in certain embodiments, access network 1004 may contain some access network nodes 1010 that support 3GPP radio access technologies (RAT), such as LTE or NR, while other access network nodes 1010 support (or the same access network nodes 1010 additionally support) non-3GPP RATs, such as Wi-Fi or a proprietary RAT. As another example, telecommunications network 1002 may support multiple generations of related communication standards (e.g., 4G and 5G 3GPP communication standards) and, as a result, may include an access network 104 and/or a core network 106 that supports multiple different standard generations or may include multiple access networks 104 and/or multiple core networks 106 with individual networks 104, 106 supporting different standard generations.

Telecommunications network 1002 may support network slicing to provide different logical networks to different devices that are connected to the telecommunications network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, one or more of the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012C and/or 1012D) and network nodes (e.g., network node 1010B). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014.

As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular if one or more of the UEs are low energy IoT devices.

The hub 1014 may have a constant/persistent or intermittent connection to the network node 1010B. The hub 1014 may also allow for a different communication scheme and/or schedule between the hub 1014 and UEs (e.g., UE 1012C and/or 1012D), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010B. In other embodiments, the hub 1014 may be a non-dedicated hub—that is, a device which is capable of operating to route communications between the UEs and network node 1010B, but which is additionally capable of operating as a communication start and/or end point for certain data channels.

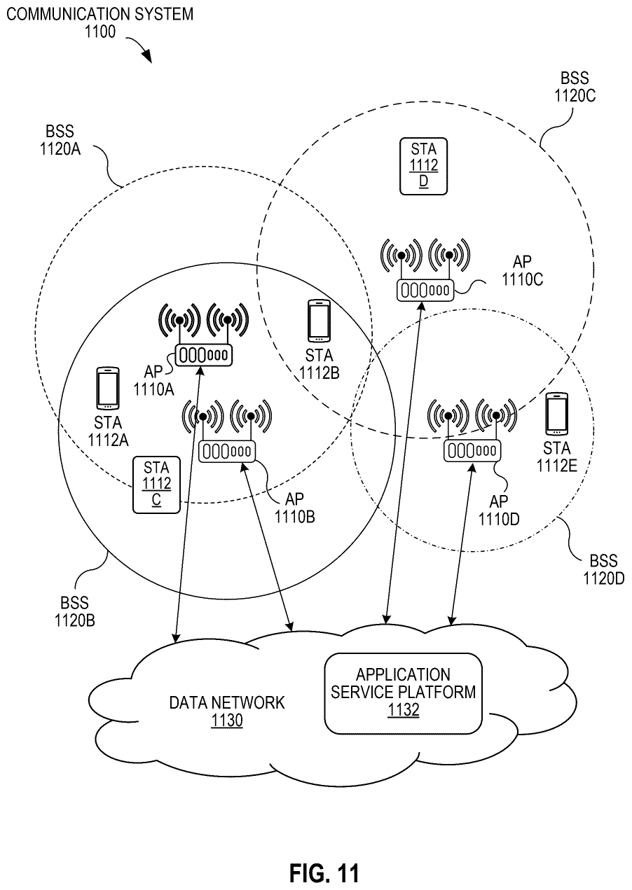

FIG. 11 is another example of a communication system 1100 according to some embodiments. As used herein, the communication system 1100 includes multiple access points (APs) 1110 (with four exemplary APs 1110A, 1110B, 1110C, and 1110D being depicted) and multiple wireless devices, referred to in the context of communication system 1100 as stations (STAs) 1112 (referred to individually as STA 1112A, STA 1112B, STA 1112C, STA 1112D, and STA 1112E). STA 1112A is served by AP 1110A in a first basic service set (BSS) 1120A. STA 1112B and STA 1112C are served by AP 1110B in a second BSS, BSS 1120B. STA 1112D is served by AP 1110C in a third BSS, BSS 1120C. STA 1112E is served by AP 1110D in a fourth BSS, BSS 1120D. Stations 1112 may be non-AP STAs and correspond to various kinds of wireless devices, for example, user terminals, such as mobile or stationary computing devices like smartphones, laptop computers, desktop computers, tablet computers, gaming devices, head-mounted displays (HMDs) for Augmented Reality (AR) or Virtual Reality (VR), or the like. Further, stations 1112 could, for example, correspond to other kinds of equipment like smart home devices, printers, multimedia devices, data storage devices, or the like.

Each of STAs 1112 may connect through a radio link to one of APs 1110. For example, depending on location or channel conditions experienced by a given STA 1112, the STA may select an appropriate AP and BSS for establishing the radio link. The radio link may be based on one or more orthogonal frequency-division multiplexing (OFDM) carriers from a frequency spectrum that is shared on the basis of a contention-based mechanism, e.g., an unlicensed or license exempt band like 2.4 GHz Industrial, Scientific, and Medical (ISM) band, the 5 GHz band, the 6 GHz band, or the 60 GHz band.

Each AP 1110 may provide data connectivity to STAs 1112 connected to a particular AP 1110. As illustrated, APs 1110 may be connected to a data network 1130. In this way, APs 1110 may also provide data connectivity between STAs 1112 and other entities, e.g., to one or more servers, service providers, data sources, data sinks, user terminals, or the like. Accordingly, the radio link established between a given STA 1112 and its serving AP 1110 may be used for providing various kinds of services to STA 1112, e.g., a voice service, a multimedia service, or other data service. Such services may be based on applications that are executed on STA 1112 and/or on a device linked to STA 1112. By way of example, FIG. 11 illustrates an application service platform 1132 provided in data network 1130. The application(s) executed on STA 1112 and/or on one or more other devices linked to STA 1112 may use the radio link for data communication with one or more other STA 1112 and/or the application service platform 1132, thereby enabling utilization of the corresponding service(s) at STA 1112.

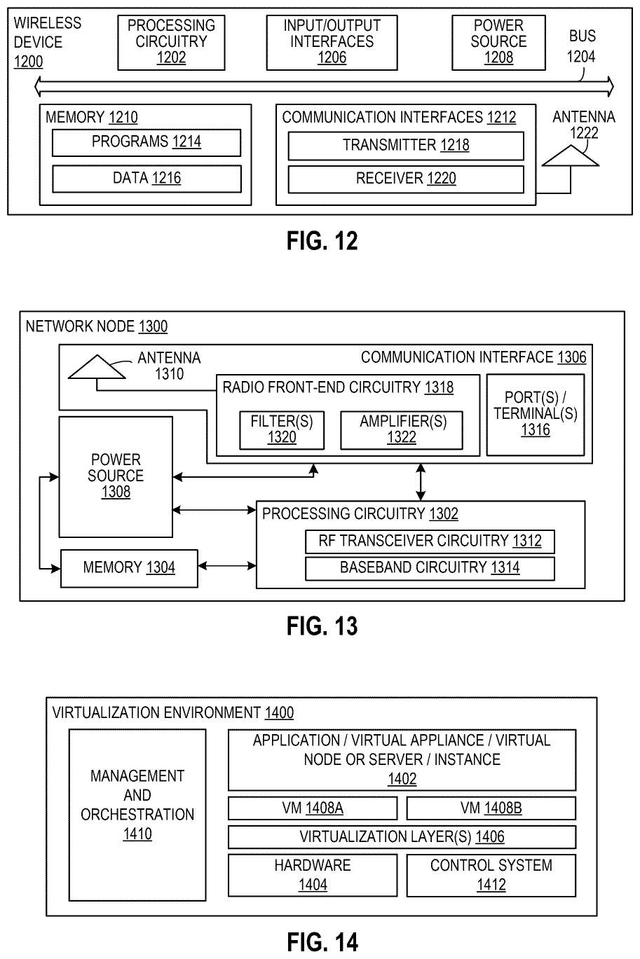

FIG. 12 shows a wireless device 1200, which may be configured to operate in communication system 1000 of FIG. 10 or in communication system 1100 of FIG. 11. The wireless device 1200 may be alternatively referred to as a UE 1200, like a UE 1012 within the context of communication system 1000, or as a station (STA) 1200 or as a non-access-point station (non-AP STA) 1200, like a STA 1112 within the context of the communication system 1100, in accordance with respective embodiments. As used herein, a wireless device refers to a device capable, configured, arranged and/or operable to communicate wirelessly with network nodes and/or other wireless devices. Examples of a wireless device include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, and wireless terminal. Other examples include any type of UE identified by the 3rd Generation Partnership Project (3GPP), including a narrow band internet of things (NB-IoT) UE, a machine type communication (MTC) UE, and/or an enhanced MTC (eMTC) UE.

A wireless device 1200 may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, wireless device 1200 may not necessarily have a user in the sense of a human user who owns and/or operates the relevant device. Instead, wireless device 1200 may represent a device that is intended for sale to, or operation by, a human user but which may not, or which may not initially, be associated with a specific human user (e.g., a smart sprinkler controller). Alternatively, wireless device 1200 may represent a device that is not intended for sale to, or operation by, an end user but which may be associated with or operated for the benefit of a user (e.g., a smart power meter).

In particular embodiments, wireless device 1200 includes processing circuitry 1202 that is operatively coupled via a bus 1204 to an input/output interface 1206, a power source 1208, a memory 1210, a communication interface 1212, and/or any other component, or any combination thereof. Certain embodiments of wireless device 1200 may include all or a subset of the components shown in FIG. 12. The level of integration between the components may vary from one embodiment of wireless device 1200 to another. In general, in a particular embodiment of wireless device 1200, processing circuitry 1202, input/output interface 1206, power source 1208, memory 1210, and communication interface 1212 may, in whole or in part, represent or include physical components common to or shared by one or more of the other elements of wireless device 1200. Further, certain embodiments of wireless devices 1200 may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into wireless device 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used to supply power to circuitry or to charge an associated battery. The power source 1208 may further include power circuitry for delivering power from the power source 1208 itself, and/or an external power source, to the various parts of wireless device 1200 via input circuitry or an interface such as an electrical power cable. Power source 1208 may perform any formatting, converting, or other modification to make accessible power suitable for the respective components of the wireless device 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more programs 1214, such as an operating system, web browser application, a widget, gadget engine, or other application, and corresponding data 1216. The memory 1210 may store, for use by wireless device 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow wireless device 1200 to access instructions, programs, and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network via or using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another wireless device or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software, or firmware, or alternatively be implemented separately.

In the illustrated embodiment, communication functions of the communication interface 1212 may include cellular communication, Wi-Fi communication (e.g., according to an IEEE 802.11 family standard), LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

In particular embodiments, wireless device 1200 may provide an output of data captured via a sensor, through its communication interface 1212, via a wireless connection to a network node, and/or in any appropriate manner. Data captured by sensors of a wireless device 1200 can be communicated through a wireless connection to a network node via another wireless device 1200. In particular embodiments, such output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, wireless device 1200 comprises an actuator, a motor, or a switch, related to a communication interface configured to receive wireless input from a network node via a wireless connection. In response to the received wireless input the states of the actuator, the motor, or the switch may change. For example, wireless device 1200 may comprise a motor that adjusts the control surfaces or rotors of a drone in flight according to the received input or to a robotic arm performing a medical procedure according to the received input.

Wireless device 1200, when in the form of an Internet of Things (IoT) device, may be a device for use in one or more application domains, these domains comprising, but not limited to, wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. In particular embodiments, wireless device 1200 represents an IoT device that comprises circuitry and/or software in dependence of the intended application of the IoT device in addition to other components as described in relation to the example embodiment of wireless device 1200 shown in FIG. 12.

As yet another specific example, in an IoT scenario, wireless device 1200 may represent a machine or other device that performs monitoring and/or measurements, and transmits the results of such monitoring and/or measurements to another wireless device and/or a network node. Wireless device 1200 may in this case be an M2M device, which may in a 3GPP context be referred to as an MTC device. As one particular example, wireless device 1200 may implement the 3GPP NB-IoT standard. In other scenarios, wireless device 1200 may represent a vehicle, such as a car, a bus, a truck, a ship and an airplane, or other equipment that is capable of monitoring and/or reporting on its operational status or other functions associated with its operation.

In practice, any number of wireless devices 1200 may be used together with respect to a single use case. For example, a first wireless device 1200 might be or be integrated in a drone and provide the drone's speed information (obtained through a speed sensor) to a second wireless device 1200 that is a remote controller operating the drone. When a user makes changes from the remote controller, the first wireless device 1200 may adjust the throttle on the drone (e.g., by controlling an actuator) to increase or decrease the drone's speed. The first and/or the second wireless device 1200 can also include more than one of the functionalities described above. For example, wireless device 1200 might comprise the sensor and the actuator, and handle communication of data for both the speed sensor and the actuators.

FIG. 13 shows a network node 1300 in accordance with some embodiments. As used herein, network node refers to equipment capable, configured, arranged and/or operable to communicate directly or indirectly with a UE and/or with other network nodes or equipment, in a telecommunications network. In accordance with respective embodiments, network node 1300 may be configured to operate in communication system 1000 of FIG. 10, like network nodes 1008 or 1010, or in communication system 1100 of FIG. 11, like an AP 1110 or a station 1112. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Network nodes 1300 may be categorized based on the amount of coverage they provide (or, stated differently, their transmit power level) and so, depending on the provided amount of coverage, may be referred to as femto base stations, pico base stations, micro base stations, or macro base stations. Network node 1300 may be a relay node or a relay donor node controlling a relay. Network nodes 1300 may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes 1300 include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

In particular embodiments, network node 1300 includes a processing circuitry 1302, a memory 1304, a communication interface 1306, and a power source 1308. In general, in a particular embodiment of network node 1300, processing circuitry 1302, memory 1304, communication interface 1306, and power source 1308 may, in whole or in part, represent or include physical components common to or shared by one or more of the other elements of network node 1300.

The network node 1300 may be composed of multiple distinct network entities (e.g., a NodeB entity and an RNC entity, or a BTS entity and a BSC entity, etc.), which may each have or utilize their own respective physical components. In certain scenarios in which the network node 1300 comprises multiple such entities (e.g., BTS and BSC), one or more of the separate entities may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memories 1304 or portions of memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, Wi-Fi (e.g., according to an IEEE 802.11 family standard), Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the RF transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data with UEs, other network nodes, and/or any other network equipment. In the illustrated embodiment, communication interface 1306 comprises port(s)/terminal(s) 1316 to send and receive data, for example to and from a network over a wired connection. In particular embodiments, network node 1300 may be capable of wireless communication and communication interface 1306 may also include radio front-end circuitry 1318 that may be coupled to, or in certain embodiments a part of, an antenna 1310. Particular embodiments of radio front-end circuitry 1318 include filter(s) 1320 and amplifier(s) 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal(s) having the appropriate channel and bandwidth parameters using a combination of filters 1320 and/or amplifiers 1322. The radio signal(s) may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, network node 1300 may be capable of wireless communication but does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through one or more interfaces or ports.

The antenna 1310, communication interface 1306, and/or the processing circuitry 1302 may be configured to perform some or all of the receiving operations and/or obtaining operations described herein as being performed by the network node 1300. Any information, data, and/or signals may be received from a UE, another network node, and/or any other network equipment. Similarly, the antenna 1310, the communication interface 1306, and/or the processing circuitry 1302 may be configured to perform some or all of the transmitting or sending operations described herein as being performed by the network node 1300. Any information, data and/or signals may be transmitted to a UE, another network node, and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as an access network node, UE, core network node, or host. Further, in embodiments in which a virtual node does not require radio connectivity (e.g., a core network node or host), then the node may be entirely virtualized. In some embodiments, the virtualization environment 1400 includes components defined by the O-RAN Alliance, such as an O-Cloud environment orchestrated by a Service Management and Orchestration Framework via an O-2 interface.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VM 1408A and VM 1408B (which may be collectively referred to as VMs 1408), and/or perform any of the functions, features and/or benefits described in relation with some embodiments described herein. The virtualization layer 1406 may present a virtual operating platform that appears like networking hardware to one or more of the VMs 1408.

The VMs 1408 comprise virtual processing, virtual memory, virtual networking or interface and virtual storage, and may be run by virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each of the VMs 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more of the VMs 1408 on top of the hardware 1404 and corresponds to an application 1402.

Hardware 1404 may be implemented in a standalone network node with generic or specific components. Hardware 1404 may implement some functions via virtualization. Alternatively, hardware 1404 may be part of a larger cluster of hardware (e.g., such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Those skilled in the art will recognize improvements and modifications to the embodiments of the present disclosure. All such improvements and modifications are considered within the scope of the concepts disclosed herein.

Some exemplary embodiments are as follows:

### Group A Embodiments

Embodiment 1: A method performed by a User Equipment, UE, (600), the method comprising: receiving (604), from a network node (602), configuration information that configures the UE (600) with one or more sets of thresholds, counters, and/or timers for beam failure detection based on Channel State Information, CSI, Reference Signal, CSI-RS, measurements on Subband Full Duplex, SBFD, symbols, non-SBFD symbols, or both SBFD and non-SBFD symbols; and performing (608) a beam failure detection procedure using the one or more configured sets of thresholds, counters, and/or timers for beam failure detection, based on CSI-RS measurements on SBFD symbols, non-SBFD symbols, or both SBFD and non-SBFD symbols.
Embodiment 2: The method of embodiment 1, wherein the one or more sets of thresholds, counters, and/or timers for beam failure detection comprise a set of thresholds, counters, and/or timers commonly applicable for CSI-RS measurements during the beam failure detection procedure regardless of whether the measurements derived based on CSI-RS resources in SBFD symbols or CSI-RS resources in non-SBFD symbols.
Embodiment 3: The method of embodiment 1, wherein the one or more sets of thresholds, counters, and/or timers for beam failure detection comprise a first set of thresholds, counters, and/or timers applicable for CSI-RS measurements during the beam failure detection procedure that are derived based on CSI-RS resources in SBFD symbols and a second set of thresholds, counters, and/or timers applicable for CSI-RS measurements during the beam failure detection procedure that are derived based on CSI-RS resources in non-SBFD symbols.
Embodiment 4: The method of any of embodiments 1 to 3, wherein each of the one or more sets of thresholds, counters, and/or timers for beam failure detection comprise a beam failure detection timer and/or a beam failure instance maximum count.
Embodiment 5: The method of any of embodiments 1 to 4, further comprising receiving (606), from the network node (602), configuration information that configures the UE (600) to derive CSI-RS measurements based on only SBFD symbols, only non-SBFD symbols, or both SBFD and non-SBFD symbols.
Embodiment 6: The method of embodiment 5, wherein the configuration information configures the UE (600) to derive CSI-RS measurements for beam failure detection based on only SBFD symbols, only non-SBFD symbols, or both SBFD and non-SBFD symbols.
Embodiment 7: The method of embodiment 5, wherein the configuration information configures the UE (600) to derive CSI-RS measurements for evaluating candidate beams or CSI-RS resources based on only SBFD symbols, only non-SBFD symbols, or both SBFD and non-SBFD symbols.
Embodiment 8: The method of embodiment 5, wherein the configuration information configures the UE (600) to derive CSI-RS measurements for both beam failure detection and beam failure recovery using the same symbol type(s) (i.e., only SBFD symbols, only non-SBFD symbols, or both SBFD and non-SBFD symbols).
Embodiment 9: The method of any of embodiments 1 to 8, further comprising, based on performing the beam failure detection procedure, sending (610), to the network node (602), a report of a beam failure event detected by the UE (600).
Embodiment 10: The method of embodiment 9, wherein: the UE (600) only reports beam failure events detected in SBFD symbols; the UE (600) only reports beam failure events detected in non SBFD symbols; or the UE (600) reports both beam failure events detected in SBFD symbols and in non-SBFD symbols.
Embodiment 11: The method of embodiment 9 or 10, wherein the report comprises any one or more of the following: a beam failure event indicator; the symbol type(s) for which the beam failure event has been detected; a time at which the beam failure event was detected; information that indicates one or more candidate beams for beam failure recover and the corresponding symbol type(s).
Embodiment 12: A method performed by a User Equipment, UE, (700), the method comprising: receiving (704), from a network node (702), configuration information that configures the UE (700) to use one or more symbols types (i.e., Subband Full Duplex, SBFD, symbols, non-SBFD symbols, or both SBFD symbols and non-SBFD symbols) for CSI-RS measurements for beam failure detection and/or beam failure recovery and/or evaluation of candidate beams or CSI-RS resources and/or RLM-related measurement activities (e.g., RLF detection); and operating (706) in accordance with the received configuration information.
Embodiment 13: A method performed by a User Equipment, UE, (800), the method comprising: receiving (804), from a network node (802), one or more CSI-RS resource configurations for Subband Full Duplex, SBFD, symbols, non-SBFD symbols, or both SBFD and non-SBFD symbols; and performing (806) CSI-RS measurements based on CSI-RS resources in SBFD symbols, non-SBFD symbols, or both SBFD symbols and non-SBFD symbols, in accordance with the one or more CSI-RS resource configurations.
Embodiment 14: The method of embodiment 13, wherein the one or more CSI-RS resource configurations comprise a CSI-RS resource configuration that is commonly applicable for CSI-RS resources in both SBFD symbols and non-SBFD symbols.
Embodiment 15: The method of embodiment 13, wherein the one or more CSI-RS resource configurations comprise a first CSI-RS resource configuration applicable for CSI-RS resources in SBFD symbols and a separate second CSI-RS resource configuration applicable for CSI-RS resources in non-SBFD symbols.
Embodiment 16: A method performed by a User Equipment, UE, (900), the method comprising: receiving (904), from a network node (902), a measurement configuration (e.g., a measurement object) comprising a reference signal configuration that includes a reference or valid symbol type indication that indicates one or more reference or valid symbols types based on which the UE (900) is to perform CSI-RS measurements for layer 3 mobility, wherein the one or more valid symbol types comprise Subband Full Duplex, SBFD, symbols, non-SBFD symbols, or both SBFD and non-SBFD symbols; and performing (906) CSI-RS measurements based on CSI-RS resources in the one or more reference or valid symbol types indicated in the measurement configuration.
Embodiment 17: The method of embodiment 16, further comprising determining (908) whether a measurement event can be triggered considering the CSI-RS measurements.
Embodiment 18: The method of embodiment 17, further comprising sending (910), to the network node (902), a measurement report for the triggered measurement event.
Embodiment 19: The method of any of the previous embodiments, further comprising: providing user data; and forwarding the user data to a host via the transmission to the network node.

### Group B Embodiments

Embodiment 20: A method performed by a network node (602), the method comprising: transmitting (604), to a User Equipment, UE, (600), configuration information that configures the UE (600) with one or more sets of thresholds, counters, and/or timers for beam failure detection based on Channel State Information, CSI, Reference Signal, CSI-RS, measurements on Subband Full Duplex, SBFD, symbols, non-SBFD symbols, or both SBFD and non-SBFD symbols.
Embodiment 21: The method of embodiment 20, wherein the one or more sets of thresholds, counters, and/or timers for beam failure detection comprise a set of thresholds, counters, and/or timers commonly applicable for CSI-RS measurements during the beam failure detection procedure regardless of whether the measurements derived based on CSI-RS resources in SBFD symbols or CSI-RS resources in non-SBFD symbols.
Embodiment 22: The method of embodiment 20, wherein the one or more sets of thresholds, counters, and/or timers for beam failure detection comprise a first set of thresholds, counters, and/or timers applicable for CSI-RS measurements during the beam failure detection procedure that are derived based on CSI-RS resources in SBFD symbols and a second set of thresholds, counters, and/or timers applicable for CSI-RS measurements during the beam failure detection procedure that are derived based on CSI-RS resources in non-SBFD symbols.
Embodiment 23: The method of any of embodiments 20 to 22, wherein each of the one or more sets of thresholds, counters, and/or timers for beam failure detection comprise a beam failure detection timer and/or a beam failure instance maximum count.
Embodiment 24: The method of any of embodiments 20 to 23, further comprising transmitting (606), to the UE (600), configuration information that configures the UE (600) to derive CSI-RS measurements based on only SBFD symbols, only non-SBFD symbols, or both SBFD and non-SBFD symbols.
Embodiment 25: The method of embodiment 24, wherein the configuration information configures the UE (600) to derive CSI-RS measurements for beam failure detection based on only SBFD symbols, only non-SBFD symbols, or both SBFD and non-SBFD symbols.
Embodiment 26: The method of embodiment 24, wherein the configuration information configures the UE (600) to derive CSI-RS measurements for evaluating candidate beams or CSI-RS resources based on only SBFD symbols, only non-SBFD symbols, or both SBFD and non-SBFD symbols.
Embodiment 27: The method of embodiment 24, wherein the configuration information configures the UE (600) to derive CSI-RS measurements for both beam failure detection and beam failure recovery using the same symbol type(s) (i.e., only SBFD symbols, only non-SBFD symbols, or both SBFD and non-SBFD symbols).
Embodiment 28: The method of any of embodiments 20 to 27, further comprising receiving (610), from the UE (600), a report of a beam failure event detected by the UE (600).
Embodiment 29: The method of embodiment 28, wherein: the UE (600) only reports beam failure events detected in SBFD symbols; the UE (600) only reports beam failure events detected in non SBFD symbols; or the UE (600) reports both beam failure events detected in SBFD symbols and in non-SBFD symbols.
Embodiment 30: The method of embodiment 28 or 29, wherein the report comprises any one or more of the following: a beam failure event indicator; the symbol type(s) for which the beam failure event has been detected; a time at which the beam failure event was detected; information that indicates one or more candidate beams for beam failure recover and the corresponding symbol type(s).
Embodiment 31: A method performed by a network node (802), the method comprising: transmitting (804), to a User Equipment, UE, (800), one or more CSI-RS resource configurations for Subband Full Duplex, SBFD, symbols, non-SBFD symbols, or both SBFD and non-SBFD symbols.
Embodiment 32: The method of embodiment 31, wherein the one or more CSI-RS resource configurations comprise a CSI-RS resource configuration that is commonly applicable for CSI-RS resources in both SBFD symbols and non-SBFD symbols.
Embodiment 33: The method of embodiment 31, wherein the one or more CSI-RS resource configurations comprise a first CSI-RS resource configuration applicable for CSI-RS resources in SBFD symbols and a separate second CSI-RS resource configuration applicable for CSI-RS resources in non-SBFD symbols.
Embodiment 34: A method performed by a network node (902), the method comprising: transmitting (904), to a User Equipment, UE, (900), a measurement configuration (e.g., a measurement object) comprising a reference signal configuration that includes a reference or valid symbol type indication that indicates one or more reference or valid symbols types based on which the UE (900) is to perform CSI-RS measurements for layer 3 mobility, wherein the one or more valid symbol types comprise Subband Full Duplex, SBFD, symbols, non-SBFD symbols, or both SBFD and non-SBFD symbols.
Embodiment 35: The method of embodiment 34, further comprising receiving (910), from the UE (900), a measurement report for a measurement event.
Embodiment 36: The method of any of the previous embodiments, further comprising: obtaining user data; and forwarding the user data to a host or a user equipment.

### Group C Embodiments

Embodiment 37: A wireless device comprising: processing circuitry configured to perform any of the operations of any of the Group A embodiments; and a power source configured to supply power to the processing circuitry.
Embodiment 38: A network node comprising: processing circuitry configured to perform any of the operations of any of the Group B embodiments; a power source circuitry configured to supply power to the processing circuitry.
Embodiment 39: A wireless device comprising: one or more antennas; communication interface connected to the one or more antennas and to processing circuitry; the processing circuitry being configured to perform any of the operations of any of the Group A embodiments; an input interface connected to the processing circuitry and configured to allow input of information into the UE to be processed by the processing circuitry; an output interface connected to the processing circuitry and configured to output information from the UE that has been 10 processed by the processing circuitry; and a power source connected to the processing circuitry and configured to supply power to the UE.

1. A method performed by a User Equipment, UE, the method comprising:
receiving, from a network node, configuration information that configures the UE with one or more sets of thresholds, counters, and/or timers for beam failure detection based on Channel State Information, CSI, Reference Signal, CSI-RS, measurements on Subband Full Duplex, SBFD, symbols, non-SBFD symbols, or both SBFD and non-SBFD symbols; and
performing a beam failure detection procedure using the one or more configured sets of thresholds, counters, and/or timers for beam failure detection, based on CSI-RS measurements on SBFD symbols, non-SBFD symbols, or both SBFD and non-SBFD symbols.

2. The method of claim 1, wherein the one or more sets of thresholds, counters, and/or timers for beam failure detection comprise a set of thresholds, counters, and/or timers commonly applicable for CSI-RS measurements during the beam failure detection procedure regardless of whether the measurements derived based on CSI-RS resources in SBFD symbols or CSI-RS resources in non-SBFD symbols.

3. The method of claim 1, wherein the one or more sets of thresholds, counters, and/or timers for beam failure detection comprise a first set of thresholds, counters, and/or timers applicable for CSI-RS measurements during the beam failure detection procedure that are derived based on CSI-RS resources in SBFD symbols and a second set of thresholds, counters, and/or timers applicable for CSI-RS measurements during the beam failure detection procedure that are derived based on CSI-RS resources in non-SBFD symbols.

4. The method of claim 1, wherein each of the one or more sets of thresholds, counters, and/or timers for beam failure detection comprise a beam failure detection timer and/or a beam failure instance maximum count.

5. The method of claim 1, further comprising receiving, from the network node, configuration information that configures the UE to derive CSI-RS measurements based on only SBFD symbols, only non-SBFD symbols, or both SBFD and non-SBFD symbols.

6. The method of claim 5, wherein the configuration information configures the UE to derive CSI-RS measurements for beam failure detection based on only SBFD symbols, only non-SBFD symbols, or both SBFD and non-SBFD symbols.

7. The method of claim 5, wherein the configuration information configures the UE to derive CSI-RS measurements for evaluating candidate beams or CSI-RS resources based on only SBFD symbols, only non-SBFD symbols, or both SBFD and non-SBFD symbols.

8. The method of claim 5, wherein the configuration information configures the UE to derive CSI-RS measurements for both beam failure detection and beam failure recovery using the same one or more symbol types, the one or more symbols types being only SBFD symbols, only non-SBFD symbols, or both SBFD and non-SBFD symbols.

9. The method of claim 1, further comprising, based on performing the beam failure detection procedure, sending, to the network node, a report of a beam failure event detected by the UE.

10. The method of claim 9, wherein:
the UE only reports beam failure events detected in SBFD symbols;
the UE only reports beam failure events detected in non SBFD symbols; or
the UE reports both beam failure events detected in SBFD symbols and in non-SBFD symbols.

11. The method of claim 9, wherein the report comprises any one or more of the following:
a beam failure event indicator;
the symbol type(s) for which the beam failure event has been detected;
a time at which the beam failure event was detected;
information that indicates one or more candidate beams for beam failure recover and the corresponding symbol type(s).

12. A User Equipment, UE, comprising:
a communication interface comprising a transmitter and a receiver; and
processing circuitry associated with the communication interface, the processing circuitry configured to cause the UE to:
receive, from a network node, configuration information that configures the UE with one or more sets of thresholds, counters, and/or timers for beam failure detection based on Channel State Information, CSI, Reference Signal, CSI-RS, measurements on Subband Full Duplex, SBFD, symbols, non-SBFD symbols, or both SBFD and non-SBFD symbols; and
perform a beam failure detection procedure using the one or more configured sets of thresholds, counters, and/or timers for beam failure detection, based on CSI-RS measurements on SBFD symbols, non-SBFD symbols, or both SBFD and non-SBFD symbols.

13-22. (canceled)

23. A method performed by a network node, the method comprising:
transmitting, to a User Equipment, UE, configuration information that configures the UE with one or more sets of thresholds, counters, and/or timers for beam failure detection based on Channel State Information, CSI, Reference Signal, CSI-RS, measurements on Subband Full Duplex, SBFD, symbols, non-SBFD symbols, or both SBFD and non-SBFD symbols.

24. The method of claim 23, wherein the one or more sets of thresholds, counters, and/or timers for beam failure detection comprise a set of thresholds, counters, and/or timers commonly applicable for CSI-RS measurements during the beam failure detection procedure regardless of whether the measurements derived based on CSI-RS resources in SBFD symbols or CSI-RS resources in non-SBFD symbols.

25. The method of claim 23, wherein the one or more sets of thresholds, counters, and/or timers for beam failure detection comprise a first set of thresholds, counters, and/or timers applicable for CSI-RS measurements during the beam failure detection procedure that are derived based on CSI-RS resources in SBFD symbols and a second set of thresholds, counters, and/or timers applicable for CSI-RS measurements during the beam failure detection procedure that are derived based on CSI-RS resources in non-SBFD symbols.

26. The method of claim 23, wherein each of the one or more sets of thresholds, counters, and/or timers for beam failure detection comprise a beam failure detection timer and/or a beam failure instance maximum count.

27. The method of claim 23, further comprising transmitting, to the UE, configuration information that configures the UE to derive CSI-RS measurements based on only SBFD symbols, only non-SBFD symbols, or both SBFD and non-SBFD symbols.

28. The method of claim 27, wherein the configuration information configures the UE to derive CSI-RS measurements for beam failure detection based on only SBFD symbols, only non-SBFD symbols, or both SBFD and non-SBFD symbols.

29. The method of claim 27, wherein the configuration information configures the UE to derive CSI-RS measurements for evaluating candidate beams or CSI-RS resources based on only SBFD symbols, only non-SBFD symbols, or both SBFD and non-SBFD symbols.

30. The method of claim 27, wherein the configuration information configures the UE to derive CSI-RS measurements for both beam failure detection and beam failure recovery using the same one or more symbol types, the one or more symbol types being only SBFD symbols, only non-SBFD symbols, or both SBFD and non-SBFD symbols.

31. The method of claim 23, further comprising receiving, from the UE, a report of a beam failure event detected by the UE.

32. The method of claim 31, wherein:
the UE only reports beam failure events detected in SBFD symbols;
the UE only reports beam failure events detected in non SBFD symbols; or
the UE reports both beam failure events detected in SBFD symbols and in non-SBFD symbols.

33. The method of claim 31, wherein the report comprises any one or more of the following:
a beam failure event indicator;
the symbol type(s) for which the beam failure event has been detected;
a time at which the beam failure event was detected;
information that indicates one or more candidate beams for beam failure recover and the corresponding symbol type(s).

34. A network node, comprising:
processing circuitry configured to cause the network node to transmit, to a User Equipment, UE, configuration information that configures the UE with one or more sets of thresholds, counters, and/or timers for beam failure detection based on Channel State Information, CSI, Reference Signal, CSI-RS, measurements on Subband Full Duplex, SBFD, symbols, non-SBFD symbols, or both SBFD and non-SBFD symbols.

35-41. (canceled)
